(19) United States
(12) Patent Application Publication
(10) Pub. No.: US 2024/0257037 A1
(43) Pub. Date: Aug. 1, 2024

(54) INFORMATION PROCESSING APPARATUS, INFORMATION PROCESSING METHOD, AND NON-TRANSITORY STORAGE MEDIUM

(71) Applicant: Toyota Jidosha Kabushiki Kaisha, Toyota-shi (JP)

(72) Inventors: Iwao NITTA, Nagoya-shi (JP); Teruyoshi Fujiwara, Toyota-shi (JP); Ryota Suzuki, Osaka (JP)

(73) Assignee: Toyota Jidosha Kabushiki Kaisha, Toyota-shi (JP)

(21) Appl. No.: 18/422,567

(22) Filed: Jan. 25, 2024

(30) Foreign Application Priority Data
Jan. 31, 2023 (JP) 2023-013056

(51) Int. Cl. G06Q 10/0835; G06Q 50/26; G06Q 50/40

(52) U.S. Cl. CPC G06Q 10/0835; G06Q 50/26; G06Q 50/40

(57) ABSTRACT

An information processing apparatus includes a controller. The controller is configured to: receive, from a terminal of a first company that belongs to a first platform, identification information of a second product of a second company and information on a second platform in which information on the second product is registered, the second company being positioned upstream of a first product of the first company in a supply chain; send a disclosure request for the information on the second product to the second platform, the disclosure request including the identification information of the second product; receive the information on the second product from the second platform in response to the disclosure request; and register the information on the second product in association with the first company.

### CROSS-REFERENCE TO RELATED APPLICATION

This application claims priority to Japanese Patent Application No. 2023-013056 filed on Jan. 31, 2023, incorporated herein by reference in its entirety.

### BACKGROUND

### 1. Technical Field

The disclosure relates to an information processing apparatus, an information processing method, and a non-transitory storage medium.

### 2. Description of Related Art

There has been suggested a system with which information on dealing products is shared between a vendor company and a customer company (see, for example, Japanese Unexamined Patent Application Publication No. 2004-171146 (JP 2004-171146 A)). With this system, information can be shared on a common platform between adjacent companies in a supply chain.

### SUMMARY

The disclosure reduces time and effort to input information on products.

A first aspect of the disclosure is an information processing apparatus. The information processing apparatus includes a controller. The controller is configured to: receive, from a terminal of a first company that belongs to a first platform, identification information of a second product of a second company, and information on a second platform in which information on the second product is registered, the second company being positioned upstream of a first product of the first company in a supply chain; send a disclosure request for the information on the second product to the second platform, the disclosure request including the identification information of the second product; receive the information on the second product from the second platform in response to the disclosure request; and register the information on the second product in association with the first company.

In the first aspect, the information on the second product may include traceability-related information of the second product.

In the first aspect, the traceability-related information may include information on an amount of emission of greenhouse effect gas.

In the first aspect, the controller may be configured to acquire information on a location of the first platform and a location of the second platform. The controller may be configured to convert the information on the amount of emission of the greenhouse effect gas according to a relationship between the location of the first platform and the location of the second platform. The information on the second product may include the converted information on the amount of emission of the greenhouse effect gas.

In the first aspect, the controller may be configured to perform at least one of the sending and the receiving via a predetermined connector.

In the first aspect, the controller may be configured to register the information about the second product in association with the first company by registering the first company as an administrator of the information on the second product.

In the first aspect, a disclosure range of the information on the second product may be designated through a terminal of the second company. The information on the second product may be received from the second platform by the controller.

In the first aspect, the first product and the second product may be products related to a battery.

A second aspect of the disclosure is an information processing method. The information processing method includes: by a computer, receiving, from a terminal of a first company that belongs to a first platform, identification information of a second product of a second company and information on a second platform in which information on the second product is registered, the second company being positioned upstream of a first product of the first company in a supply chain; sending a disclosure request for the information on the second product to the second platform, the disclosure request including the identification information of the second product; receiving the information on the second product from the second platform in response to the disclosure request; and registering the information on the second product in association with the first company.

In the second aspect, the information on the second product may include traceability-related information of the second product.

In the second aspect, the traceability-related information may include information on an amount of emission of greenhouse effect gas.

In the second aspect, the information processing method may include, by the computer, acquiring information on a location of the first platform and a location of the second platform, and converting the information on the amount of emission of the greenhouse effect gas according to a relationship between the location of the first platform and the location of the second platform. The registering the information on the second product may include registering the converted information on the amount of emission of the greenhouse effect gas in association with the first company.

In the second aspect, the information processing method may include, by the computer, the performing at least one of the sending and the receiving via a predetermined connector.

In the second aspect, the registering the information on the second product in association with the first company may include registering the first company as an administrator of the information on the second product.

In the second aspect, a disclosure range of the information on the second product may be designated through a terminal of the second company. The information on the second product may be received from the second platform by the computer.

In the second aspect, the first product and the second product may be products related to a battery.

A third aspect of the disclosure is a non-transitory storage medium storing instructions that are executable on one or more processors in a computer and that cause the one or more processors to perform functions. The functions include: receiving, from a terminal of a first company that belongs to a first platform, identification information of a second product of a second company and information on a second platform in which information on the second product is registered, the second company being positioned upstream of a first product of the first company in a supply chain; sending a disclosure request for the information on the second product to the second platform, the disclosure request including the identification information of the second product; receiving the information on the second product from the second platform in response to the disclosure request; and registering the information on the second product in association with the first company.

In the third aspect, the information on the second product may include traceability-related information of the second product.

In the third aspect, the traceability-related information may include information on an amount of emission of greenhouse effect gas.

In the third aspect, the functions may include acquiring information on a location of the first platform and a location of the second platform, and converting the information on the amount of emission of the greenhouse effect gas according to a relationship between the location of the first platform and the location of the second platform. The registering the information on the second product may include registering the converted information on the amount of emission of the greenhouse effect gas in association with the first company.

According to the first, second, and third aspects of the disclosure, it is possible to reduce time and effort to input information on products.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that illustrates an example of a supply chain according to a first embodiment;

FIG. 2 is a diagram that illustrates an example of a relationship among products supplied by the supply chain;

FIG. 3 is a diagram that shows the outline of a process executed between a server apparatus and company terminals;

FIG. 4 is a hardware configuration diagram of the server apparatus according to the first embodiment;

FIG. 5 is a hardware configuration diagram of each company terminal according to the first embodiment;

FIG. 6 is a software configuration diagram of the server apparatus according to the first embodiment;

FIG. 7 is a software configuration diagram of each company terminal according to the first embodiment;

FIG. 8 is an example of product information generated by a product information generating unit;

FIG. 9 is an example of a screen output by an authority setting unit;

FIG. 10 is an example of permission information generated by the authority setting unit based on information input;

FIG. 11 is an example of a user interface containing a list of products that are candidates to be associated;

FIG. 12 is a diagram that shows an example of the flow of a process executed by the server apparatus;

FIG. 13 is a diagram that illustrates a product tree and the amount of carbon dioxide emitted in each process;

FIG. 14 is an example of a screen on which a product tree is output in form of an image;

FIG. 15 is an example of a product tree in a case where products of which no access authority is given are undisclosed;

FIG. 16 is a sequence diagram that illustrates a process executed by the server apparatus and the company terminal in first to third phases;

FIG. 17 is a sequence diagram that illustrates a process executed by the server apparatus and the company terminal in a fourth phase;

FIG. 18 is a diagram that illustrates an example of a relationship among products in two supply chains;

FIG. 19 is a table that shows an example of product information generated by an information collecting unit or a proxy input unit;

FIG. 20 is a sequence diagram that shows an example of the flow of a process in which a first server apparatus acquires second product information from a second server apparatus; and

FIG. 21 is a flowchart that shows the flow of a process of registering a second product, executed in the first server apparatus.

### DETAILED DESCRIPTION OF EMBODIMENTS

Carbon footprint (Carbon Footprint of Products (CFP)) is a mechanism for converting the amount of emission of greenhouse effect gas emitted through the entire life cycle from raw material procurement of commercial products to disposal and recycling to CO₂ emission amount and indicating the CO₂ emission amount on the commercial products. To implement CFP, traceability in which suppliers involved from raw material procurement of commercial products to disposal and recycling are recorded and a history is placed in a traceable state is important. On the other hand, when a supplier supplies products to a plurality of companies, different platforms can be respectively used for supply destinations even when a target product is the same. In this case, the supplier is required to input the same information to each platform, so it take time and effort to input information. This inconvenience is not limited to a scene to collect carbon footprint. The inconvenience can arise in, for example, every scene to collect selected information on products, such as other traceability-related information (for example, a raw material recycling rate, due diligence information, or the like) and information on the other products (for example, constituent elements, identification information, and the like).

An information processing apparatus that is one of the aspects of the disclosure includes a control unit. The control unit is configured to: receive, from a terminal of a first company that belongs to a first platform, identification information of a second product of a second company, positioned upstream of a first product of the first company in a supply chain, and information on a second platform in which information on the second product is registered; send a disclosure request for the information on the second product to the second platform, the disclosure request including the identification information of the second product; receive the information on the second product from the second platform in response to the disclosure request; and register the information on the second product in association with the first company.

The first platform and the second platform are platforms that manage information on products of companies. The first platform and the second platform respectively manage supply chains. A plurality of companies belongs to one of the supply chains, and a plurality of companies belongs to the other one of the supply chains. The first company is a company that makes up a supply chain together with other companies and is a company that belongs to the first platform. The second company is a company that makes up a supply chain together with other companies and is a company that belongs to the second platform. The first company may belong to both the first platform and the second platform.

The first product of the first company includes the second product of the second company. The first product is a product on a root node side with respect to the second product. For example, the second product may be used in a manufacturing process for the first product. For example, the first product and the second product may be the same product. In this case, for example, the first company may be a company that transports the first product. The first product and the second product may be, for example, materials, stand-alone parts, assembly parts, finished commercial products, or the like. However, since information on the second product of the second company is not registered in the first platform, information on the second product is desired to be input to ensure traceability. For this reason, the control unit receives identification information of the second product and information on the second platform to which the second company belongs, from the terminal of the first company. The information on the second product is already input in the second platform. The control unit sends a disclosure request for the information on the second product to the second platform. At this time, the control unit sends a disclosure request including the identification information of the second product to the second platform. The second platform having received the disclosure request sends the information on the second product to the first platform. In this way, the control unit can acquire the information on the second product, so it is possible to register the information on the second product in the first platform.

When the information on the second product is registered in the first platform, the second company has not joined the first platform. Therefore, the control unit registers the information on the second product in association with the first company. At this time, the information on the second product may be, for example, registered such that other companies cannot find what company the second product is supplied from. In this way, it is possible to register the information on the second product based on information received from the first company, so traceability is ensured. At this time, the second company does not need to newly input the information on the second product.

The information processing apparatus may be a server of the first platform. In another method, the information processing apparatus may be a server that is independent of the first platform and that provides the first platform with information acquired from the second platform.

The information on the second product may include traceability-related information of the second product. The traceability-related information is information required to ensure traceability. The traceability-related information is typically information for calculating the amount of emission of greenhouse effect gas, the recycling rate of raw material, a score for due diligence, or the like. With this configuration, the second company can save time and effort to input the traceability-related information of the second product multiple times. The first company can ensure traceability even when the second company does not input the traceability-related information to the first platform.

The traceability-related information may include information on an amount of emission of greenhouse effect gas. With this configuration, the second company can save time and effort to input the amount of emission of greenhouse effect gas related to the second product multiple times. The first company can acquire the amount of emission of greenhouse effect gas of the second product even when the second company does not input the amount of emission of greenhouse effect gas of the second product to the first platform. The information on the amount of emission of greenhouse effect gas related to the second product may be information on the total amount of greenhouse effect gas emitted by the time the second product is obtained or may be information on the amount of greenhouse effect gas emitted in relation to a manufacturing activity for the second product in the second company.

The control unit may be further configured to acquire information on a location of the first platform and a location of the second platform; and convert the information on the amount of emission of the greenhouse effect gas according to a relationship between the location of the first platform and the location of the second platform. The registering the information on the second product may include registering the information on the amount of emission of the converted greenhouse effect gas in association with the first company. Here, when the location of the first platform is different from the location of the second platform, it is presumable that the utilization factor of renewable energy of energy supplied varies. Then, even when the same product is manufactured, it is presumable that the amount of emission of greenhouse effect gas varies depending on the location. In contrast, when the amount of greenhouse effect gas is converted according to the location, it is possible to increase the accuracy of CFP. When the converted information on the amount of emission of greenhouse effect gas is registered in association with the first company, it is possible to ensure traceability. The location of the platform may be a region from which information on traceability is collected. When, for example, a Japanese platform is made up of a server disposed in other than Japan, the location of the platform is Japan, and is not a location where the server is disposed.

The control unit may perform at least one of the sending and the receiving via a predetermined connector. It is also conceivable that different connectors are respectively used in the first platform and in the second platform. It is possible to send and receive information between the platforms via a predetermined connector corresponding to each platform.

The registering the information on the second product in association with the first company may include registering the first company as an administrator of the information on the second product. When the first company is registered as an administrator, it is possible for the first company to correct the information on the second product. However, since the first company will have more management responsibility on the second product that is not its own company's product, the first company does not need to be registered as an administrator and may be registered as a proxy applicant. The first company does not need to be called to account for management of the information on the second product. For example, contact information to the second company may be held in the first platform, and the first platform may automatically contact the second company to manage the information.

The information on the second product, received from the second platform by the control unit, may be information of which a range of disclosure is designated through a terminal of the second company. Since the second company can designate the range of disclosure, it is possible, for example, not to disclose information of which disclosure is restricted by laws and regulations or confidential information, so it is possible to increase the convenience of the second company.

The first product and the second product may be products related to a battery. In other words, the first product and the second product may be products used at the time of manufacturing a battery. With this configuration, it is possible to ensure traceability on a battery.

Hereinafter, embodiments of the disclosure will be described with reference to the accompanying drawings. The configurations of the following embodiments are illustrative, and the disclosure is not limited to the configurations of the embodiments. The following embodiments may be combined as long as possible.

### First Embodiment

A system according to the present embodiment is a system that provides information on products supplied by a supply chain including a plurality of companies. Information on products is typically information on traceability.

Initially, the structure of a supply chain will be described. In an example, at least some companies (intermediate suppliers) included in the supply chain can receive parts from one or more upstream companies, produce their own company's products by using the parts received, and supply their own company's products produced to companies (downstream companies) in the next process. A most upstream company can directly produce its own company's products and supply its own company's products produced to a company in the next process. Some companies of the supply chain can directly supply (that is, be involved in distribution of) products received from another company to a different company. A plurality of companies repeats this flow, and final products are obtained in the last process.

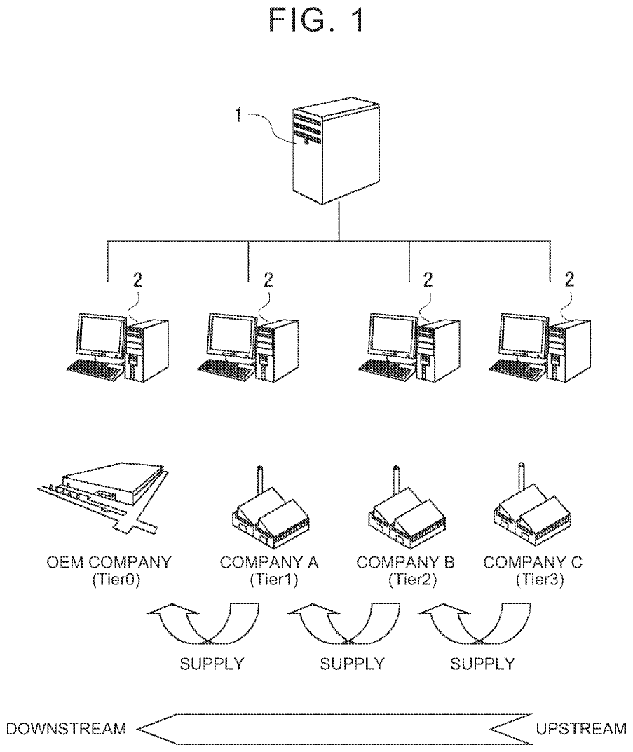

FIG. 1 is a diagram that illustrates an example of the supply chain according to the present embodiment. In the example of FIG. 1, a scene where products on automobiles are obtained is assumed. Specifically, the supply chain shown in FIG. 1 is made up of an OEM company and a plurality of companies that are suppliers. The OEM company is a company that provides end products assembled, and the companies (Company A, Company B, and Company C) that are suppliers are companies that supply parts, materials, assemblies, and the like for manufacturing end products. The companies that are suppliers each produce a plurality of products and supply the products to companies at a level lower by one. The companies repeat this flow, and assembly of final products is performed in the last process.

In the present embodiment, a side that supplies products at one level is referred to as an upstream side, and a side that purchases the products and produces new products is referred to as a downstream side. In the specification, a company positioned at the upstream side is referred to as an upstream company, and a company positioned at the downstream side is referred to as a downstream company. Products produced by an upstream company are referred to as upstream products, and products produced by a downstream company are referred to as downstream products. Downstream products include upstream products.

In the present embodiment, levels in the supply chain are referred to as Tiers. Tier0 is the lowest level that provides final products assembled (that corresponds to the OEM company), and, as the level advances in order of Tier1, Tier2, and Tier3, the level shifts toward the upstream side. Depending on a level focused, a downstream company may be changed to an upstream company. For example, Company B in Tier2 is a downstream company in relation to Tier3 but is an upstream company in relation to Tier1. In this way, the definition of upstream company and downstream company can change level by level.

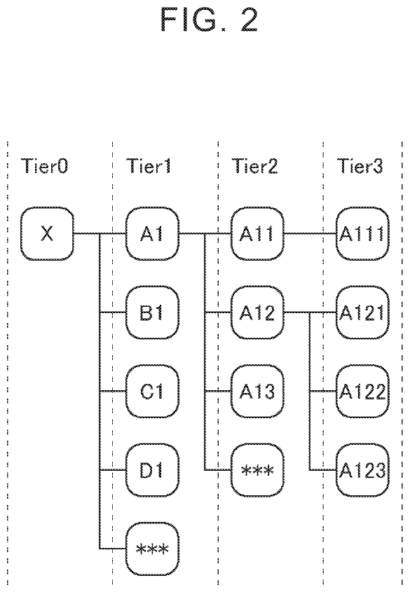

FIG. 2 is a diagram that illustrates an example of a relationship among products supplied by a supply chain. Here, a supply relationship of a plurality of products that make up an end product X is represented by a tree diagram. In this example, the end product X is produced by assembling products A1, B1, C1, D1, . . . . The product A1 is produced by assembling products A11, A12, A13, . . . . In this way, a relationship among a plurality of products that make up an end product can be represented by a tree diagram with individual products as nodes. Hereinafter, a tree diagram on a specific end product is referred to as a product tree. In an example, the end product X is a battery to be mounted on a battery electric vehicle (BEV). In another example, the end product X may be an automobile or a product relevant to an automobile, such as an assembly of an automobile.

A server apparatus 1 according to the present embodiment collects information on products produced by companies (hereinafter, product information) and information for associating pieces of product information from terminals corresponding to companies (company terminals 2) and generates a product tree based on these pieces of information. Product information includes information on traceability (for example, information on the amount of emission of greenhouse effect gas, or the like; hereinafter, referred to as “traceability-related information”). It is possible to trace carbon footprint or the like by tracking a product trec. Traceability-related information may include every information that can be a target to ensure traceability.

As shown in FIG. 1, the information processing system according to an example of the present embodiment includes the server apparatus 1 and the company terminals 2. The company terminals 2 are terminals respectively corresponding to the companies that make up the supply chain. The company terminals 2 included in the system may be multiple. The server apparatus 1 collects information for generating a product tree from each of the company terminals 2 and generates a product tree based on these pieces of information. Furthermore, the server apparatus 1 is capable of executing a process on traceability (typically, a process of calculating the amount of emission of carbon dioxide, or the like) based on the product tree generated. The server apparatus 1 is also capable of sending the execution result of the process to the company terminals 2.

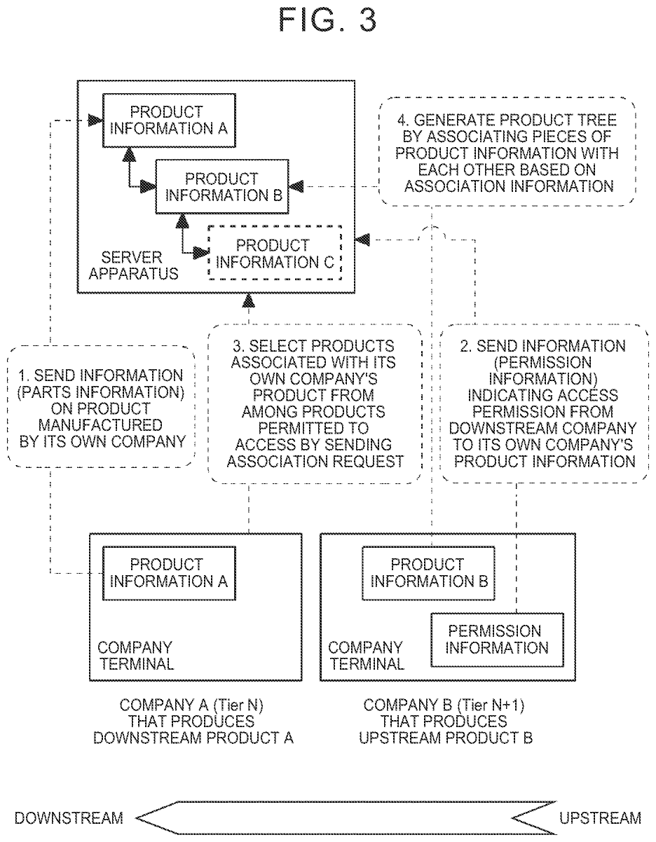

Next, the outline of a process in which the server apparatus 1 generates a product tree will be described with reference to FIG. 3. FIG. 3 is a diagram that shows the outline of a process executed between the server apparatus 1 and the company terminals 2. In the example of FIG. 3, it is assumed that, at a selected level, there are Company A that is a downstream company and Company B that is an upstream company. It is assumed that Company B produces a product B and supplies the product B to Company A and Company A produces a product A by using the product B. In other words, in the example of FIG. 3, the product B is a child node of the product A in the product trec.

To generate a product tree, the company terminals 2 respectively corresponding to the companies each send information on products produced by itself to the server apparatus 1. In this example, the company terminal 2 corresponding to Company A sends product information on the product A (referred to as product information A) to the server apparatus 1. Similarly, the company terminal 2 corresponding to Company B sends product information on the product B (referred to as product information B) to the server apparatus 1. The product information of each company is stored in the server apparatus 1.

An operation to associate the pieces of product information stored in the server apparatus 1 is performed by the company terminal 2. In an example, a person in charge of the downstream company logs onto the server apparatus 1 from the company terminal 2 with an account of the downstream company and selects an upstream product with which the downstream product that is its own company's product is associated. In this way, association of pieces of product information with each other is performed from the downstream product to the upstream product. The server apparatus 1 associates the pieces of product information based on the selection.

However, when a product with which a product is associated is selected, if products in the supply chain and pieces of information on the products all are presented as choices, confidentiality of both information on companies that make up the supply chain and information on products produced by the companies is impaired. Furthermore, it may not be reasonable to disclose the whole of the product tree to one supplier.

For this reason, the server apparatus 1 according to the present embodiment gives in advance authority to access product information of an upstream product to a downstream company in response to a request from an upstream company. The server apparatus 1 permits access from the downstream company within the range of authority given.

In the example of FIG. 3, the company terminal 2 corresponding to Company B that is an upstream company sends the server apparatus 1 a request (information) to provide instructions to “give Company A authority to access the product information B”. When the server apparatus 1 receives a request regarding association from the company terminal 2 corresponding to Company A, the server apparatus 1 provides only a list of pieces of product information of which access authority is given to Company A and prompts for selecting as a target to be associated. When there is a request to access the product tree from the company terminal 2 corresponding to Company A, the server apparatus 1 provides the company terminal 2 with a product tree in which information other than information to which access authority is given to Company A is concealed. Thus, it is possible to conceal information on irrelevant companies and products.

### Hardware Configuration

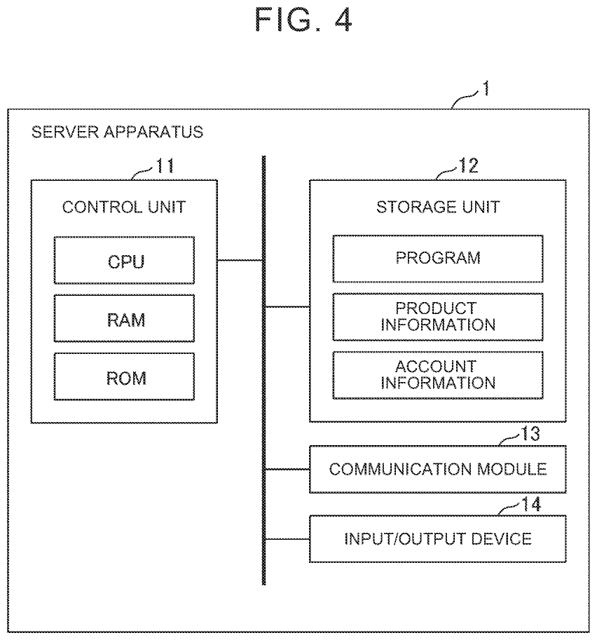

Next, the hardware configuration of each of the devices that make up the system will be described with reference to FIG. 4. FIG. 4 is a diagram that schematically shows an example of the hardware configuration of the server apparatus 1 according to the present embodiment. The server apparatus 1 is configured as a computer including a control unit 11, a storage unit 12, a communication module 13, and an input/output device 14.

The server apparatus 1 may be configured as a computer including a processor (a CPU, a GPU, or the like), a main storage device (a RAM, a ROM, or the like), and an auxiliary storage device (an EPROM, a hard disk drive, a removable medium, or the like). An operating system (OS), various programs, various tables, and the like are stored in the auxiliary storage device. Various functions (software modules) that match predetermined purposes as will be described later can be implemented by running the programs stored in the auxiliary storage device. One, some, or all of the modules may be implemented as hardware modules by a hardware circuit, such as an ASIC and an FPGA. The control unit 11 is an arithmetic unit that implements various functions of the server apparatus 1 by running predetermined programs. The control unit 11 can be implemented by, for example, a hardware processor, such as a CPU. The control unit 11 may be configured to include a RAM, a read only memory (ROM), a cache memory, or the like.

The storage unit 12 is a device that stores information and is a storage medium, such as a RAM, a magnetic disk, and a flash memory. Programs to be run on the control unit 11, data used by the programs, and the like are stored in the storage unit 12. A database is constructed in the storage unit 12. Product information collected from the company terminals 2 and account information on companies are stored in the database. Details will be described later.

The communication module 13 is a communication interface for connecting the server apparatus 1 with a network. The communication module 13 may be configured to include, for example, a network interface board, a wireless communication interface for wireless communication, and the like. The server apparatus 1 is capable of performing data communication with another computer (for example, another server apparatus 1 or each company terminal 2) via the communication module 13.

The input/output device 14 is a device that receives an input operation performed by an operator and presents information to the operator. Specifically, the input/output device 14 includes a device for inputting, such as a mouse and a keyboard, and a device for outputting, such as a display and a speaker. The input/output device 14 may be, for example, integrally configured by a touch panel display or the like.

For a specific hardware configuration of the server apparatus 1, omissions, replacements, or additions of components are applicable as needed according to embodiments. For example, the control unit 11 may include a plurality of hardware processors. The hardware processor may be a microprocessor, an FPGA, a GPU, or the like. The input/output device 14 may be omitted or an input/output device (for example, an optical disk drive or the like) other than the illustrated one may be added. The server apparatus 1 may be made up of a plurality of computers. In this case, the hardware configuration of each computer may be the same or may be different.

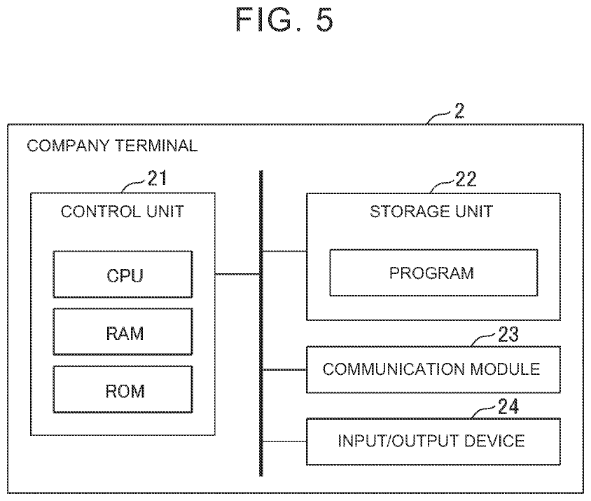

FIG. 5 is a diagram that schematically shows an example of the hardware configuration of the company terminal 2 according to the present embodiment. The company terminal 2 is configured as a computer including a control unit 21, a storage unit 22, a communication module 23, and an input/output device 24.

The company terminal 2, as in the case of the server apparatus 1, may be configured as a computer including a processor (a CPU, a GPU, or the like), a main storage device (a RAM, a ROM, or the like), and an auxiliary storage device (an EPROM, a hard disk drive, a removable medium, or the like). One, some, or all of the functions (software modules) may be implemented as hardware modules by a hardware circuit, such as an ASIC and an FPGA.

The control unit 21 is an arithmetic unit that implements various functions (software modules) of the company terminal 2 by running predetermined programs. The control unit 21 can be implemented by, for example, a hardware processor, such as a CPU. The control unit 21 may be configured to include a RAM, a read only memory (ROM), a cache memory, or the like.

The storage unit 22 is a device that stores information and is a storage medium, such as a RAM, a magnetic disk, and a flash memory. Programs to be run on the control unit 21, data used by the programs, and the like are stored in the storage unit 22.

The communication module 23 is a communication interface for connecting the company terminal 2 with a network. The communication module 23 may be configured to include, for example, a network interface board, a wireless communication interface for wireless communication, and the like. The company terminal 2 is capable of performing data communication with another computer (for example, the server apparatus 1) via the communication module 23.

The input/output device 24 is a device that receives an input operation performed by an operator and presents information to the operator. Specifically, the input/output device 24 includes a device for inputting, such as a mouse and a keyboard, and a device for outputting, such as a display and a speaker. The input/output device 24 may be, for example, integrally configured by a touch panel display or the like.

For a specific hardware configuration of the company terminal 2, as in the case of the server apparatus 1, omissions, replacements, or additions of components are applicable as needed according to embodiments.

### Software Configuration

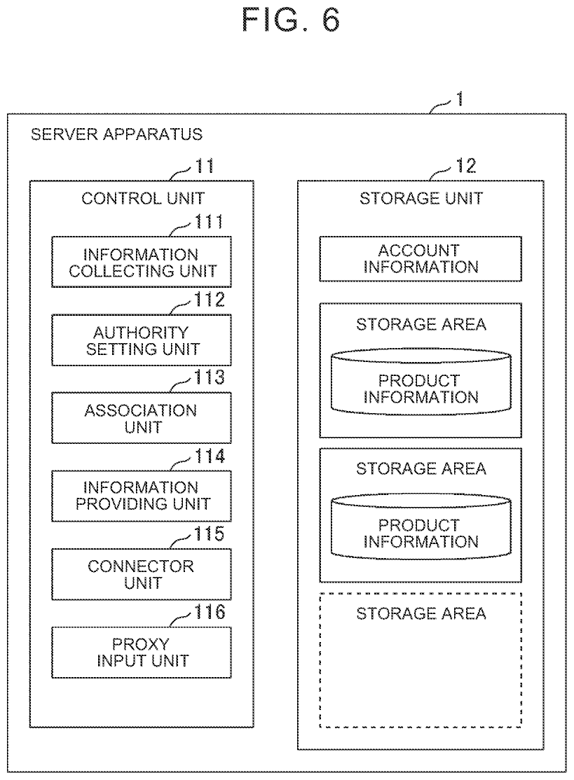

Next, the software configuration of each of the devices that make up the system will be described with reference to FIG. 6. FIG. 6 is a diagram that schematically shows an example of the software configuration of the server apparatus 1 according to the present embodiment. In the present embodiment, the control unit 11 is configured to include six software modules, that is, an information collecting unit 111, an authority setting unit 112, an association unit 113, an information providing unit 114, a connector unit 115, and a proxy input unit 116. The software modules may be implemented by the control unit 11 (CPU) running the programs stored in the storage unit 12. Information processing executed by the information collecting unit 111, the authority setting unit 112, the association unit 113, the information providing unit 114, the connector unit 115, and the proxy input unit 116 is synonymous with information processing executed by the control unit 11.

The information collecting unit 111 is configured to execute a process of receiving product information sent from the company terminal 2 and storing the product information in the storage unit 12. The authority setting unit 112 is configured to receive information for setting authority to access product information (hereinafter, permission information) from the company terminal 2. Furthermore, the authority setting unit 112 is configured to execute a process of setting authority to access the product information stored in the storage unit 12 based on the information received.

The association unit 113 is configured to acquire information for associating pieces of product information with each other, from the company terminal 2 by performing interaction with the company terminal 2. Furthermore, the association unit 113 is configured to execute a process of writing information indicating an association relationship on the product information stored in the storage unit 12 based on the information acquired. The association unit 113 is configured to execute a process of receiving a request to give termination information and giving the termination information to the product information stored in the storage unit 12 in response to this request. A product tree is formed by reflecting association and giving termination. In other words, forming a product tree is saving association information and termination information in the storage unit 12. The association unit 113 is configured to generate a product tree according to the result of association and giving termination.

The information providing unit 114 is configured to execute information processing relevant to a product tree and output a result obtained by executing information processing. The information processing relevant to a product tree may include a process of performing computation on traceability for a product trec. Outputting the result obtained by executing information processing may include a process of providing the company terminal 2 with information on the product tree generated. In an example, the information providing unit 114 is configured to generate information on a product tree and output information on the product tree generated.

The connector unit 115 includes an application used for communication related to the platforms. Communication between a plurality of the server apparatuses 1 may be performed via the connector units 115. The connector unit 115 may be configured to, for example, execute a process on data communication of authorization, encryption of communication, and the like. The connector unit 115 may be configured to, for example, control access to each piece of data based on rules, such as laws and regulations and contracts. In an example, the connector unit 115 may be an application used for communication related to the platforms, such as an international data spaces (IDS) connector and an eclipse dataspace connector (EDC).

The proxy input unit 116 is configured to execute a process of receiving product information sent from another platform and storing the product information in the storage unit 12.

In the present embodiment, the storage unit 12 is configured to include a plurality of logical storage areas. Different access authority can be set to each of the plurality of storage areas like, for example, an area in which access authority is given to Company A, an area in which access authority is given to Company B, and an area in which access authority is given to both Company A and Company B. The authority setting unit 112 sets access authority by storing product information received from the company terminal 2 in an appropriate storage area. A specific processing method will be described later.

Account information is stored in the storage unit 12. In the present embodiment, an operator of each company logs onto the server apparatus 1 by using a corresponding account of the company via the company terminal 2 to perform interaction between the server apparatus 1 and the company terminal 2. Account information is information on an account corresponding to each of the companies that make up the supply chain. Logging on by using an account is an example of a corresponding company accessing the server apparatus 1. However, a method of accessing the server apparatus 1 is not limited to such an example and may be selected as needed according to embodiments.

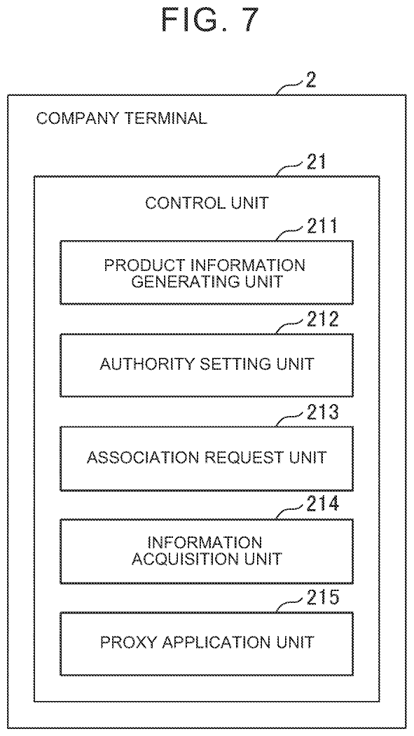

FIG. 7 is a diagram that schematically shows the software configuration of the company terminal 2 according to the present embodiment. In the present embodiment, the control unit 21 is configured to include five software modules, that is, a product information generating unit 211, an authority setting unit 212, an association request unit 213, an information acquisition unit 214, and a proxy application unit 215. The software modules may be implemented by the control unit 21 (CPU) running the programs stored in the storage unit 22. Information processing executed by the product information generating unit 211, the authority setting unit 212, the association request unit 213, the information acquisition unit 214, and the proxy application unit 215 is synonymous with information processing executed by the control unit 21.

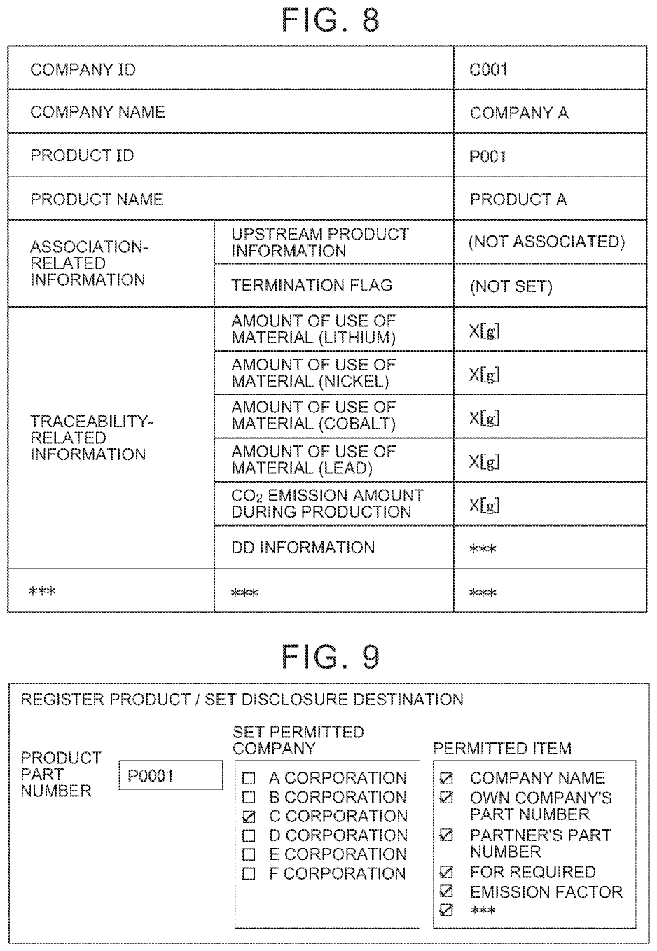

The product information generating unit 211 is configured to generate information on products (product information) of the company corresponding to the company terminal 2. FIG. 8 is an example of product information generated by the product information generating unit 211. Product information may be input via an operator of the device. In the present embodiment, product information is configured to include fields of company ID, company name, product ID, and product name. A company ID and a company name are respectively an identifier and a name of a company that produces a target product (that is, a company that uses the company terminal 2). A product ID and a product name are respectively an identifier and a name of the target product.

Furthermore, product information is configured to include association-related information. Association-related information is information for identifying an upstream product associated with the target product. In the present embodiment, association-related information includes fields of “upstream product information” and “termination flag”.

The upstream product information field is configured to store information for identifying product information corresponding to the upstream product (that is, a product needed to produce the target product and included in the target product) associated with the target product. The upstream product information field is used when the server apparatus 1 associates products with each other. Basically, in the phase in which product information is generated, the target product is not associated with the upstream product, so a value indicating the upstream product does not need to be stored in the upstream product information field.

The termination flag field is configured to store a flag indicating whether a target product is a leaf node in a product tree, that is, a node positioned at the most upstream side (end). In the present embodiment, since the company terminals 2 send product information, the flag is used to determine whether a product is further associated on the upstream side or no more association occurs (a target product is positioned at the most upstream side) for a product in a product tree. In other words, the termination flag field is used at the time when the server apparatus 1 finalizes association of products with each other. Basically, in the phase in which product information is generated, an association relationship of the target product is not determined, so “0 (currently not a termination)” may be stored in the termination flag field. Finally, to generate a product tree, product information of each company, stored in the server apparatus 1, is set to a state of any one of “association with the upstream product has been performed” and “the termination flag is set to “1””.

Furthermore, product information is configured to include traceability-related information. In an example, traceability-related information may include the amount of use of materials (for example, upstream products) per the amount of production of products, information on the recycling rate of predetermined raw materials, the amount of emission of greenhouse effect gas emitted at the time of producing products (CFP value), due diligence-related information, or a combination of some of them. Examples of the predetermined raw materials may include lithium, nickel, cobalt, lead, and graphite. The recycling rate may be directly represented or may be indirectly represented like, for example, a combination of a total use amount and the amount of use of recycled materials. These values are values corresponding to a process of producing a target product. For example, in the example of FIG. 3, the amount of greenhouse effect gas, or the like, emitted in production activity for the product A is stored in the traceability-related information included in the product information A. The traceability-related information included in the product information A does not include information on a process until an upstream product is produced (for example, the amount of greenhouse effect gas emitted by the time the upstream product B is produced, or the like).

The traceability-related information may be selected as needed according to embodiments. In an example, the amount of emission of greenhouse effect gas (carbon footprint) may include the amounts of emission of scope 1, scope 2, and scope 3. The scope 1 may be the amount of direct emission of greenhouse effect gas by itself. The scope 2 may be the amount of indirect emission resulting from use of electricity, heat, and vapor supplied from another company. The scope 3 may be the amount of indirect emission other than the scope 1 or the scope 2. In an example, the due diligence-related information may be a technical document indicating that, for a product that contains a target raw material (for example, cobalt, natural graphite, lithium, nickel, or the like), proves that obligations of the amount of raw materials contained in the product and responsible mineral procurement of a smelter or the like are fulfilled. In another example, the due diligence-related information may include a score indicating a degree to which the obligations are fulfilled.

The product information generating unit 211 is configured to acquire such information via the operator of the company terminal 2 and send the information to the server apparatus 1 at selected timing.

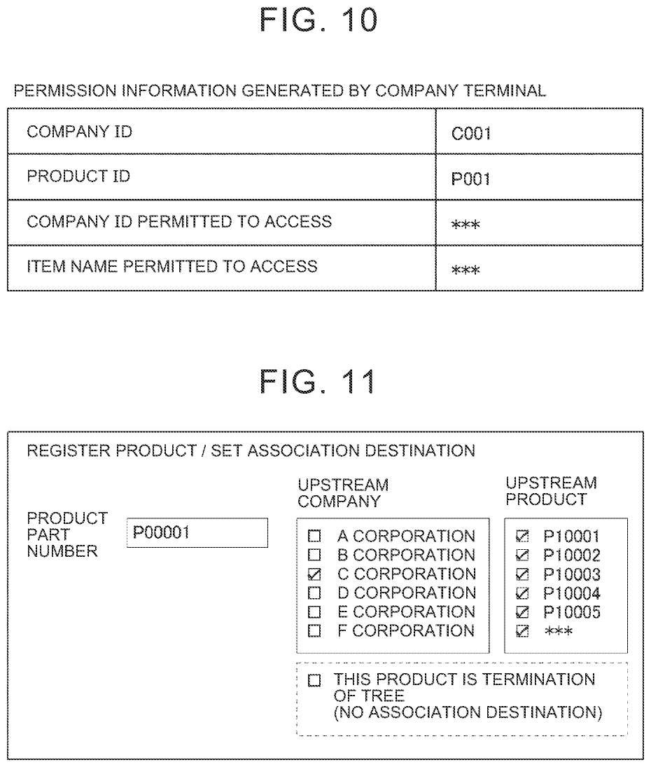

The authority setting unit 212 is configured to designate a downstream company permitted to access product information sent from the company terminal 2 to the server apparatus 1. FIG. 9 is an example of a screen output by the authority setting unit 212. As shown in the drawing, the authority setting unit 212 is configured to receive designation of a downstream company permitted to access a selected own company's product. FIG. 10 is an example of permission information generated by the authority setting unit 212 based on information input. The authority setting unit 212 is configured to send permission information to the server apparatus 1 at selected timing. Access authority may be set in units of product information or may be set in units of item included in product information (“permission item” in the table). Thus, for example, partial disclosure like, for example, the presence of a product is disclosed but specific information on materials used, the amount of use, and the like is not disclosed, is possible.

A list of companies shown on the screen of FIG. 9 may be a list of companies having dealt with the own company in the past. Therefore, the server apparatus 1 may store data on past deal (dealing data) for each company and generate a list of companies based on the dealing data. Dealing data may include, for example, an identifier of a target product, an identifier of a company that produces the product, a date of deal, and the like.

The association request unit 213 is configured to make a request of the server apparatus 1 to associate its own company's product information sent to the server apparatus 1 with an upstream product. In an example, initially, the association request unit 213 sends its own company ID and product ID to the server apparatus 1 and makes a request of the server apparatus 1 to associate the product ID with corresponding product information. In contrast, the server apparatus 1 generates a user interface containing a list of product information (that is, candidates to be associated) permitted to access from a target company and provides the user interface generated to the company terminal 2. FIG. 11 is an example of the user interface containing a list of products permitted to access from a target company.

The list of products shown in FIG. 11 may be a list of products that have been dealt with its own company in the past. The server apparatus 1 may generate the list further based on the dealing data stored.

Subsequently, the association request unit 213 is configured to allow the operator to select an upstream product to be associated, from the list. The association request unit 213 is configured to send an identifier of a product that is a source of association (downstream product) and an identifier of an upstream product that is a destination of association in pair to the server apparatus 1. The server apparatus 1 is allowed to associate pieces of product information with each other accordingly.

When there is no upstream product associated with a target product, it is possible to explicitly indicate the fact by, for example, checking a checkbox indicated by the dashed line in FIG. 11. In this case, association of pieces of product information with each other is not performed.

The information acquisition unit 214 is configured to make a request of the server apparatus 1 to provide a product tree and output information sent from the server apparatus 1. The proxy application unit 215 is configured to execute a process of making a request of the server apparatus 1 to register product information of an upstream product.

### Details of Process on Formation of Product Tree

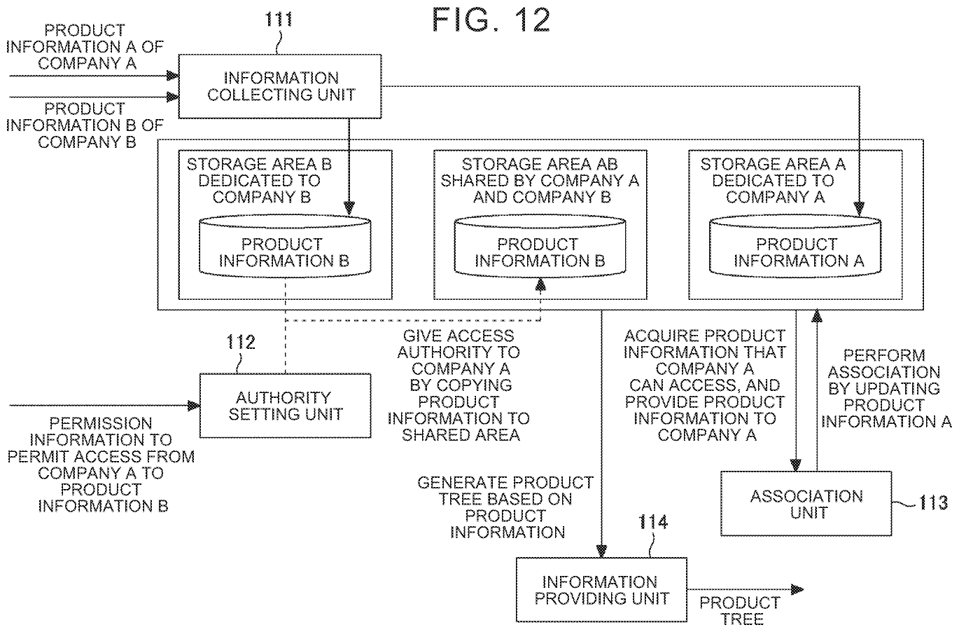

Next, specific details of a process executed by the server apparatus 1 and the company terminal 2 will be described. FIG. 12 is a diagram that shows an example of the flow of a process executed by the server apparatus 1 based on a request from the company terminal 2. The process executed by the server apparatus 1 is divided into the following four phases:
(1) a first phase in which product information sent from the company terminal 2 is received and the product information received is stored;
(2) a second phase in which permission information sent from the company terminal 2 is received and authority to access the product information is set according to the permission information received;
(3) a third phase in which pieces of product information are associated with each other by performing interaction with the company terminal 2; and
(4) a fourth phase in which information on a product tree is provided based on the result of association.

In the example of FIG. 12, it is assumed that Company A is a downstream company and Company B is an upstream company. It is also assumed that a product produced by Company A is a product A and a product produced by Company B is a product B. It is also assumed that product information corresponding to the product A is product information A and product information corresponding to the product B is product information B.

In the first phase, the information collecting unit 111 of the server apparatus 1 acquires product information from the product information generating unit 211 of the company terminal 2. In the example of FIG. 12, the server apparatus 1 acquires the product information A from the company terminal 2 corresponding to Company A and acquires the product information B from the company terminal 2 corresponding to Company B. The information collecting unit 111 saves the product information A in a storage area of which access authority is given to only Company A (hereinafter, storage area A). The information collecting unit 111 saves the product information B in a storage area of which access authority is given to only Company B (hereinafter, storage area B). In this way, the information collecting unit 111 saves product information sent from any company in a dedicated storage area of which access authority is given to only the company.

In the second phase, the authority setting unit 112 of the server apparatus 1 receives permission information from the authority setting unit 212 of the company terminal 2 and sets authority to access product information according to the permission information received. Permission information is the one that associates a product with a company that permits access to product information of the product as shown in FIG. 10.

In the example of FIG. 12, it is assumed that the authority setting unit 112 receives permission information to permit access from Company A that is the downstream company to the product information B of the upstream company. In this case, the authority setting unit 112 copies the product information B stored in the storage area B to a storage area of which access authority is given to both Company A and Company B (hereinafter, storage area AB). Thus, the product information B is placed in a state accessible from both Company A and Company B. When authority to access a specific item included in product information is not set, the item is excluded from those to be copied to the storage area AB.

In the following description, a storage area of which access authority is given to only a specific company is referred to as “dedicated storage area”, and a storage area of which access authority is given to a plurality of companies is referred to as “shared storage area”.

Production information is copied by the server apparatus 1 in response to reception of permission information from the company terminal 2. In other words, the company terminal 2 sends permission information to the server apparatus 1 to cause the server apparatus 1 to execute an operation to copy product information identified by the permission information from a dedicated storage area of a target company to a shared storage area accessible from a downstream company.

In the third phase, the association unit 113 of the server apparatus 1 receives an association request from the association request unit 213 of the company terminal 2 and associates pieces of product information with each other based on the association request received.

Initially, the association unit 113 receives an association request from the company terminal 2. The association request is sent from the company terminal 2 of a downstream company. In the example of FIG. 12, it is assumed that the company terminal 2 of Company A has sent an association request. The association request includes a company ID and a product ID of a target product. The association unit 113 acquires product information stored in a storage area accessible from the company and generates a list of product information acquired. In the example of FIG. 12, the product information B stored in the storage area AB is accessible from Company A. Therefore, in the company terminal 2 of Company A, the product information B is selectable as a destination of association.

The association request unit 213 of the company terminal 2 presents a list to an operator and allows the operator to select products to be associated. In the case of this example, the product A and the product B are targets to be associated with each other. The operator, for example, inputs information indicating that the upstream product is the product B for the product A via the input/output device 24. The association request unit 213 sends data for associating the upstream product (product B) with the downstream product (product A) (association data) to the association unit 113.

As illustrated in FIG. 8, product information has a field on a product that is a destination of association (association-related information). The association unit 113 stores information corresponding to the product information B (that is, the upstream product) in the association-related information of the product information A based on the above-described association data. For example, an identifier of an upstream product, an identifier of a company that produces the upstream product, and the like are stored in the association-related information.

A pointer or the like to product information that is a destination of association may be stored in the association-related information. A pointer is to point out the address or the like of product information corresponding to an upstream product. With the process described above, part of a tree structure in which product information of the downstream product is a parent node and product information of the upstream product is a child node is formed.

At the terminal of the product tree, further more association is not performed. In this case, the association request unit 213 sends data indicating that the product is the terminal of a tree instead of sending association data. When the association unit 113 receives the data, the association unit 113 sets “1” to the termination flag field of corresponding product information. In other words, in the third phase, any one of “a process of setting an upstream product that is a destination of association” and “a process of setting a termination flag” is executed.

In the fourth phase, the information providing unit 114 of the server apparatus 1 generates information on a product tree based on the product information stored and outputs information on the product tree. Generating information on a product tree may include a process of, after a link between nodes is formed by association of pieces of product information with each other, generating various pieces of information on products (for example, information on traceability, an image representing a link relationship between products in a tree diagram, or the like). To generate information on a product tree, all the association of pieces of product information with each other needs to be complete, and “1” needs to be set to the termination flags of all the leaf nodes. When such conditions are satisfied, the information providing unit 114 is allowed to appropriately generate the information.

A product tree according to the present embodiment, as described with reference to FIG. 2, is the one representing a supply relationship among pieces of product information in a supply chain in a tree diagram. The information providing unit 114 is capable of generating an image representing a tree diagram based on product information.

Furthermore, when the information providing unit 114 generates information on a product tree, the information providing unit 114 integrates traceability-related information defined in each piece of product information with one another and outputs the result.

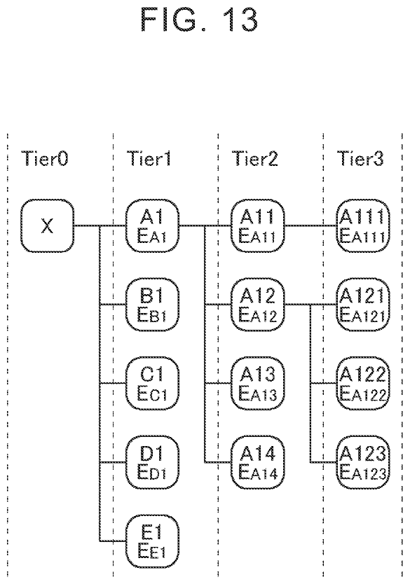

Here, integration of traceability-related information will be described with reference to FIG. 13. FIG. 13 is a diagram that illustrates a plurality of products that make up an end product X and the amount of carbon dioxide (CO₂) emitted in each process to produce these plurality of products. For example, it is assumed that, in a process of producing a product A12 in the diagram, E_{A12} [g] of carbon dioxide is emitted. It is also assumed that the product is made up of three upstream products A121, A122, A123. In this way, an upstream product included in a product is also referred to as “inclusion product”. Here, a total amount of carbon dioxide emitted by the time a target product is produced can be obtained by repeating a process of transferring a CO₂ emission amount associated with an upstream product to a downstream product between companies of two adjacent layers from a most upstream product that is a leaf node to the target product.

In the example of FIG. 13, when the target product is A12, a CO₂ emission amount corresponding to inclusion products (upstream products A121, A122, A123) and a CO₂ emission amount corresponding to the product A12 are added up. Thus, it is possible to calculate the total amount of carbon dioxide emitted by the time the product A12 is produced. In other words, the CO₂ emission amount integrated for the product A12 is as follows.

$${I}_{A 12} = {E}_{A 12} + {E}_{A 121} \times {U}_{A 121} + {E}_{A 122} \times {U}_{A 122} + {E}_{A 123} \times {U}_{A 123} \qquad [ g ]$$

Here, it is assumed that E_{A121}, E_{A122}, and E_{A123} are respectively the CO₂ emission amounts per unit amount at the time of producing the corresponding products A121, A122, A123. U_{A121}, U_{A122}, and U_{A123} are respectively the amounts of use of the products A121, A122, A123 used to produce the product A12. The amount of use is an example of the amount of use of material per the amount of production of a product, included in the traceability-related information. The CO₂ emission amount of an end product (a product of a most downstream company) can be obtained by sequentially performing the computation from the product of the most upstream company to the end product.

The same applies to a case where the target product is a product A1. When the target product is A1, it is possible to calculate the total amount of carbon dioxide emitted in manufacturing activity until the product A1 is produced by integrating the CO₂ emission amount corresponding to the product A1 with the CO₂ emission amounts corresponding to products A11, A12, A13, A14 that are inclusion products.

An integrated value may be stored in the storage unit 12 in association with a product or may be included in part of product information. In other words, product information corresponding to the product A12 may hold both E_{A12} that is the amount of emission in the process alone and I_{A12} that is the amount of emission after integration.

Traceability-related information after integration is used again at the time of performing integration for a downstream product. When this process is executed at each level with the most upstream side as a starting point, traceability-related information (for example, an accumulated value of the CO₂ emission amount) is sequentially transferred in a downstream direction. Finally, the traceability-related information is transferred to an end product. As a result, traceability-related information corresponding to the entire period until the end product is produced (for example, the total amount of emission of CO₂) can be obtained.

In this way, when the information providing unit 114 generates information on a product trec, the information providing unit 114 may repeatedly execute a process of sequentially integrating traceability-related information defined for each piece of product information from the most upstream side toward the most downstream side. In the above-described example, the amount of emission of carbon dioxide is illustrated as a target of integration; however, traceability-related information that is a target of integration may be a recycling rate related to a predetermined raw material, a score for due diligence, or the like. When the traceability-related information is a numeric value, integration may be performed by mathematical operations. When the traceability-related information is information other than a numerical value (for example, due diligence-related information or the like), integration may be simple information collection.

In another example, product information may include information indicating a location of traceability-related information of a corresponding product (hereinafter, “location information”; typically, address, pointer, or the like). In this case, traceability-related information does not need to be included in product information. Integration may be to collect location information included in product information.

The information providing unit 114 may output a product tree generated in an image format. Simultaneously, the information providing unit 114 may output traceability-related information corresponding to a selected product.

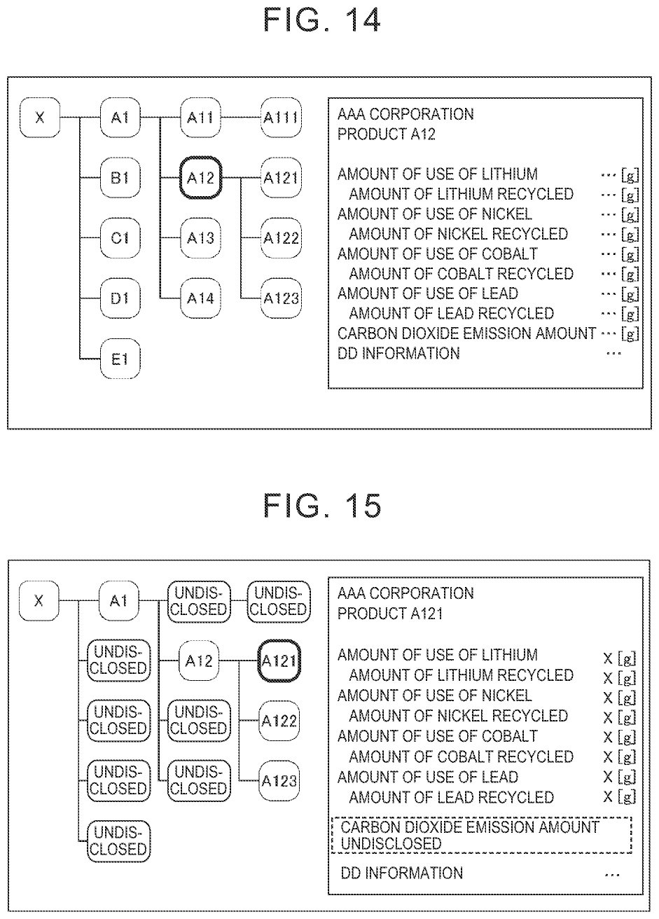

FIG. 14 is an example of a screen in which a product tree is output in form of an image. The illustrated screen contains an image representing a supply relationship among a plurality of products that make up an end product in a tree diagram. When a product is selected, traceability-related information corresponding to the product or an integration result of traceability-related information until the product is produced (for example, a total value of the amount of emission of carbon dioxide from the most upstream side) is allowed to be browsed. Such information can be output via the input/output device 14 of the server apparatus 1 based on an operation of an operator of the server apparatus 1.

Furthermore, the information providing unit 114 may provide a product tree generated to the company terminal 2 in response to a request from the company terminal 2 (information acquisition unit 214). It may be not adequate to disclose the entire product tree to a specific company. For this reason, when the information providing unit 114 provides a product tree to the company terminal 2 corresponding to a company, the information providing unit 114 may execute a process of not disclosing a range of which no access authority is given to the company.

For example, in the example of FIG. 13, it is assumed that the information providing unit 114 receives a request to disclose a product tree from the company terminal 2 corresponding to a company that produces the product A12. Here, it is assumed that authority to access only the products A121, A122, A123 is given to the company. In other words, the company cannot access product information other than the above three products and A1 that is a downstream product. In this case, the information providing unit 114 provides a product tree in which information on products of which no access authority is given is undisclosed, to the company terminal 2.

FIG. 15 is an example of a product tree in a case where products of which no access authority is given are undisclosed. In this example, a product tree is shown in a state where detailed information (or the presence) of the products that are undisclosed is confidential.

In a case where the presence of a product is disclosed but authority to access only a specific item in corresponding product information is not given, a confidential process is executed only on the specific item as indicated by the dashed line in the diagram. In the illustrated example, the fact that the amount of emission of carbon dioxide at the time of producing the product A121 is undisclosed is shown.

On the other hand, even when there is a product (or item) of which no access authority is given in a tree, the above-described integration of traceability-related information is performed without any influence. For example, in the illustrated example, the amount of emission of carbon dioxide for the product A121 is undisclosed; however, this does not influence the process of calculating the total amount of emission of carbon dioxide for the product A12.

### Flow of Process

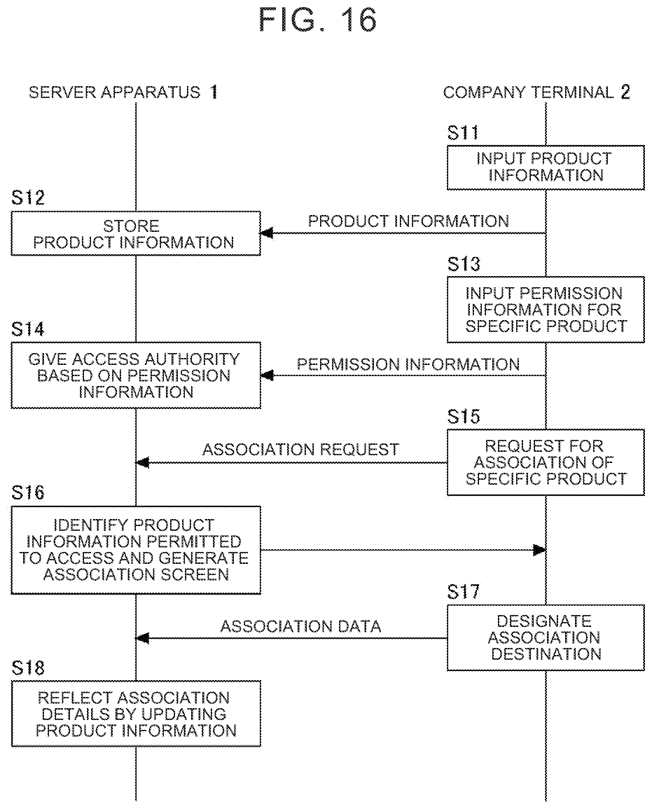

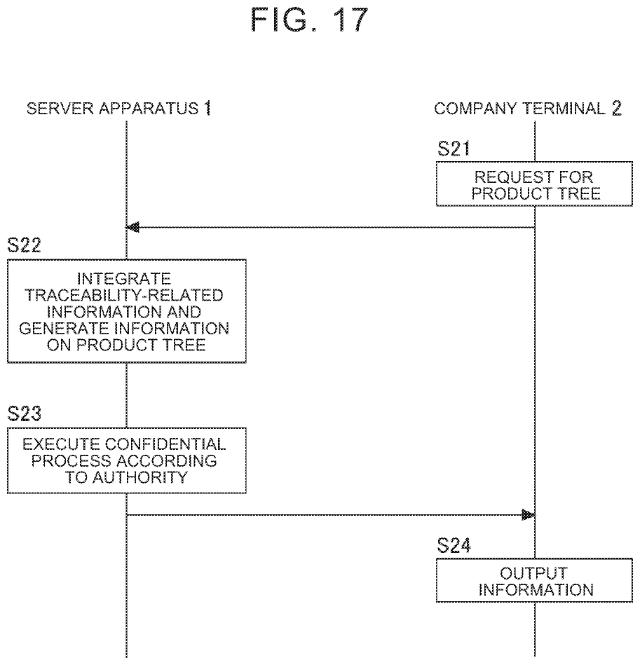

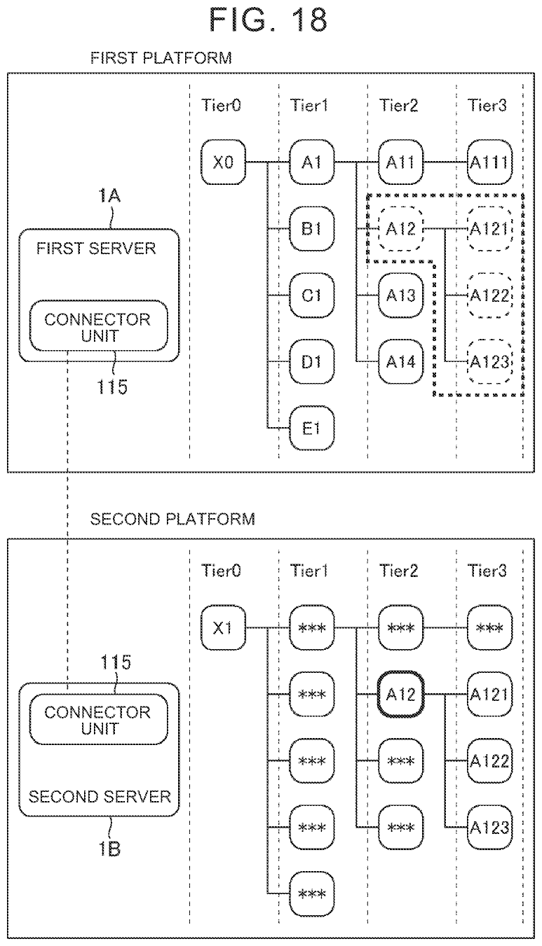

Next, the flow of a process executed by the server apparatus 1 and the company terminal 2 in a case where its own company's product information is registered by the company terminal 2 will be described with reference to FIG. 16 and FIG. 17. FIG. 16 is a sequence diagram corresponding to the first to third phases.

In an example, interaction between the server apparatus 1 and the company terminal 2 is started when the operator of each company logs onto the server apparatus 1 by using the corresponding account of the company via the company terminal 2. In this example, it is assumed that the operator of each company has logged onto the server apparatus 1 by using its own company's account.

Initially, in step S11, the product information generating unit 211 of the company terminal 2 acquires its own company's product information via the operator and sends the product information acquired to the server apparatus 1. The product information sent is received by the server apparatus 1 (information collecting unit 111) and stored in the storage unit 12 (step S12). At this time, the information collecting unit 111 saves the product information in a storage area of which access authority is given to only the company that produces the corresponding product.

After that, in step S13, the authority setting unit 212 of the company terminal 2 receives, via the operator, input of information to designate a downstream company permitted to access (permission information) the product information sent in step S11. In this step, a user interface screen as described with reference to FIG. 9 may be provided, and a combination of a selected product with a downstream company permitted to access the product information may be allowed to be designated. The permission information input is sent to the server apparatus 1.

In step S14, the authority setting unit 112 of the server apparatus 1 gives authority to access target product information based on the permission information received. In this step, as described with reference to FIG. 12, the authority setting unit 112 gives authority to access selected product information to a selected company by copying the target product information to a storage area of which access authority is given to a plurality of companies. When there is no appropriate storage area of which access authority is given, the authority setting unit 112 may execute a process of generating a new storage area and giving access authority to an appropriate company.

Subsequently, in step S15, the association request unit 213 of the company terminal 2 sends data to make a request of the server apparatus 1 to associate the product information sent to the server apparatus 1 with an upstream product (association request). The association request includes its own company ID and a product ID of a target product.

In step S16, the server apparatus 1 (association unit 113) generates a list of product information permitted to access from a target company and provides the company terminal 2 with a user interface screen containing the list. In this step, the server apparatus 1 may provide a user interface screen as described with reference to FIG. 11 to the company terminal 2 and designate a combination of a selected product with an upstream product associated with the product.

In step S17, the association request unit 213 of the company terminal 2 receives from the operator a designated combination of a target product with an upstream product associated with the product. The association request unit 213 generates data indicating association of an upstream product with a downstream product (association data) and sends the association data generated to the server apparatus 1.

In step S18, the association unit 113 of the server apparatus 1 updates the product information stored based on the association data and reflects details of association of the pieces of product information with each other. Association of pieces of product information with each other may be performed by storing information (identifier, pointer, or the like) on an upstream product with association-related information of product information of a downstream product.

When there is no downstream company, processes of step S13 to step S14 may be omitted. Similarly, when there is no upstream company (when there is no destination of association for a target product), the association unit 113 may execute a process of setting the above-described termination flag instead of making a request to associate pieces of product information with each other. In this case, the processes of the above-described step S15 to step S18 are omitted.

FIG. 17 is a sequence diagram corresponding to the above-described fourth phase. Initially, in step S21, the information acquisition unit 214 of the company terminal 2 makes a request of the server apparatus 1 to provide a product tree. The request includes, for example, an identifier of a target product. The target product may be an end product or may be a product other than the end product (intermediate product).

The server apparatus 1 (information providing unit 114) having received the request generates information on a product tree through the above-described process (step S22). At this time, the information providing unit 114 executes a process of integrating traceability-related information defined for each piece of product information from the most upstream side toward the most downstream side. The result of integration may be reflected on each piece of product information.

Subsequently, in step S23, the server apparatus 1 executes a process of placing information, of which no access authority is given, in a confidential state based on the access authority of a target company. When, for example, the presence itself of product information of another company is not disclosed to a company, the server apparatus 1 may execute a process of placing the presence of the product information in a confidential state. When only a specific item included in product information is undisclosed, the server apparatus 1 may execute a process of placing the details of the item in a confidential state. Information on a product tree subjected to the confidential process is provided to the company terminal 2 (information acquisition unit 214) and output (step S24).

### Details of Process of Registering Product Information of Upstream Company

The proxy input unit 116 of the server apparatus 1 is capable of acquiring and storing product information from a server apparatus 1 of another platform. Here, when a downstream company desires to associate its own company's product with an upstream product but the upstream product is not registered in the platform, it is not possible to perform the association. In the present embodiment, to deal with this situation, the proxy input unit 116 registers information on a product of a company that has not joined the supply chain based on a request from a company that has already joined the supply chain.

FIG. 18 is a diagram that illustrates an example of a relationship among products in two supply chains. It is assumed that two supply chains are respectively formed in a first platform and a second platform. In FIG. 18, in the first platform, a supply relationship of a plurality of products that make up an end product X0 is represented by a tree diagram. In the second platform, a supply relationship of a plurality of products that make up an end product X1 is represented by a tree diagram. For example, the first platform and the second platform are respectively formed in different countries or different regions. Hereinafter, the server apparatus 1 corresponding to the first platform is referred to as a first server apparatus 1A, and the server apparatus 1 corresponding to the second platform is referred to as a second server apparatus 1B. The first server apparatus 1A and the second server apparatus 1B are capable of communicating with each other via the connector units 115. However, it is not indispensable that the first server apparatus 1A and the second server apparatus 1B communicate with each other via the connector units 115, and the first server apparatus 1A and the second server apparatus 1B may be configured to communicate with each other without intervening the connector units 115.

The product information of the product A1 is registered in the first platform. On the other hand, the product information of the product A12 that is the upstream product of the product A1 is registered in the second platform but is not registered in the first platform. Hereinafter, the downstream-side product A1 is referred to as a first product A1, and the product A12 positioned at a level upstream by one from the first product A1 is referred to as a second product A12. The proxy input unit 116 of the first server apparatus 1A receives a request to register the second product A12 from the proxy application unit 215 of the company terminal 2 of a company that manufactures the first product A1. Hereinafter, a company that manufactures the first product A1 is referred to as a first company, and a company that manufactures the second product A12 is referred to as a second company. The company terminal of the first company is referred to as a first company terminal 2A, and the company terminal of the second company is referred to as a second company terminal 2B.

Initially, the proxy application unit 215 of the first company terminal 2A makes a request of the second company terminal 2B to send information on the platform that the second product A12 has joined (that is, the second platform) and identification information of the second product A12. In response to this, the information on the second platform that the second product A12 has joined and the identification information of the second product A12 are sent from the proxy application unit 215 of the second company terminal 2B to the first company terminal 2A. The identification information of the second product A12 is, for example, information including a product ID and a product name stored in the second platform. A method of acquiring the information on the second platform and the identification information of the second product A12 are not limited to such an example. An operator of the first company may acquire the information on the second platform and the identification information of the second product A12 with a selected method (for example, outside the system).

The proxy application unit 215 of the first company terminal 2A acquires second product information from the second platform and makes a request of the first server apparatus 1A to register the second product information acquired in the first platform. At this time, the proxy input unit 116 of the first server apparatus 1A receives the identification information of the second product A12 of the second company and the information on the second platform from the proxy application unit 215 of the first company terminal 2A. The proxy input unit 116 of the first server apparatus 1A sends a disclosure request that is a request to disclose information on the second product A12 to the second server apparatus 1B. A disclosure request is sent or received via the corresponding connector unit 115. The disclosure request includes the identification information of the second product A12. In this case, the disclosure request includes, for example, a request to disclose traceability-related information. The disclosure request may include information with which it is possible to determine what kind of information is required to be disclosed (for example, information indicating an item that is a target of the disclosure request). There can be a case where information required is different between the first platform and the second platform, so only information required in the first platform may be required to be disclosed.

The proxy input unit 116 of the second server apparatus 1B having received a disclosure request identifies the second product based on the identification information. In response to the disclosure request, the proxy input unit 116 of the second server apparatus 1B sends information on the second product A12 to the first server apparatus 1A. At this time, information is sent or received via the corresponding connector unit 115. Before the information on the second product A12 is sent, the proxy input unit 116 of the second server apparatus 1B may make inquiries of the second company terminal 2B about whether the information on the second product A12 is allowed to be disclosed or may make inquiries of the second company terminal 2B about the range of disclosure of information on designation of a downstream company permitted to access.

When the proxy input unit 116 of the first server apparatus 1A receives the information on the second product A12 from the second server apparatus 1B, the proxy input unit 116 registers the information on the second product A12 in association with the first company. In this way, when the first company submits proxy application to register the second product A12, it is possible to register information on the second product A12 in the first platform. Thus, the second company does not need to input information on the second product A12 to the first platform by itself, so it is possible to reduce time and effort for input.

At the point in time when the information on the second product A12 is registered in the first platform, the second company has not joined the first platform. In this case, it is problematic who manages the information on the second product A12 in the first platform. For example, when there is a change in traceability-related information of the second product A12, how procedure information is changed should be determined; otherwise, there is a concern that information is not updated. In contrast, for example, registration of the second product A12 may be managed by the first company. In other words, the first company may be registered as an administrator of the second product A12. In this case, the second product A12 may be registered as a product of the first company. For example, in the product information shown in FIG. 8, the company ID and company name corresponding to the first company may be stored in the fields of company ID and company name.

However, the first company needs more time and effort to manage information on the second product A12 that is not its own company's product. Therefore, the first company does not need to be called to account for management of the information on the second product A12 registered through proxy application. For example, the first server apparatus 1A may hold contact information to the second company and may update information by making inquiries of the second company about, for example, a predetermined interval from the first server apparatus 1A.

Not limited to this configuration, the second product information just needs to be stored in the first server apparatus 1A such that the fact that the second product information is registered through proxy application from the first company can be determined. For example, the corresponding company ID and company name may be respectively stored in the fields of the company ID and company name when the first company submits proxy application. In further another method, the information collecting unit 111 may generate a company ID corresponding to the second company, and the company ID and the company name corresponding to the second company may be respectively input to the fields of the company ID and company name. In addition, fields for storing a company that submits proxy application may be provided, and the company ID and company name of the first company may be stored. In another method, the fields of company ID and company name may be blank, fields for storing a company that submits proxy application may be provided, and the company ID and company name of the first company may be stored.

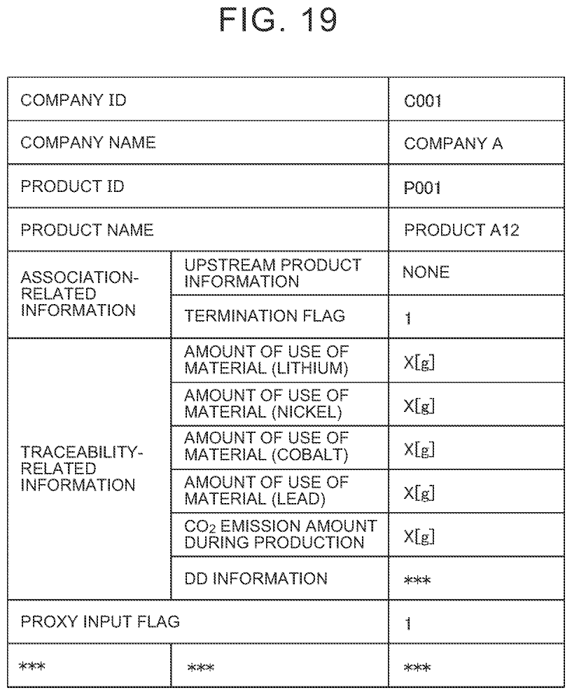

To identify product information registered through proxy application, the product information stored in the server apparatus 1 may be configured to have a proxy input flag field. FIG. 19 is a table that shows an example of product information generated by the information collecting unit 111 or the proxy input unit 116. The proxy input flag field is used to determine product information registered through proxy application. “1” is stored in the proxy input flag field in a case of being registered through proxy application, and “0” is stored in the proxy input flag field in a case of being registered based on product information sent from the company terminal 2. Therefore, when product information acquired from the company terminal 2 is stored in the storage unit 12, “0” is stored in the proxy input flag field by the information collecting unit 111. When product information acquired from the second server apparatus 1B is stored in the storage unit 12, “1” is stored in the proxy input flag field by the proxy input unit 116.

The proxy input unit 116 of the first server apparatus 1A gives authority to access the second product information based on permission information received from the second server apparatus 1B. As described with reference to FIG. 12, the proxy input unit 116 of the first server apparatus 1A gives authority to access selected product information to a selected company by copying the second product information to a storage area of which access authority is given to a plurality of companies. For example, the proxy input unit 116 of the first server apparatus 1A stores the identification information of the second product A12 in the upstream product information field in the product information of the first product A1. Authority to access the second product information received from the second server apparatus 1B may be given to only the first company.

Even when the second product A12 is registered in the first platform, it may be difficult to register further upstream products A121, A122, A123 in the first platform. For example, the products A121, A122, A123 cannot be seen from the first company of the first product A1. In this case, the first company cannot submit proxy application to register the products A121, A122, A123. Since the second company also has not joined the first platform, the second company cannot submit proxy application to register the products A121, A122, A123. Therefore, “1” is set for the termination flag of the second product information of the second product A12. The products A121, A122, A123 become black boxes in the product tree. When the CO₂ emission amount I_{A12} integrated for the second product A12 is stored as the second product information, it is possible to ensure traceability.

### Flow of Process

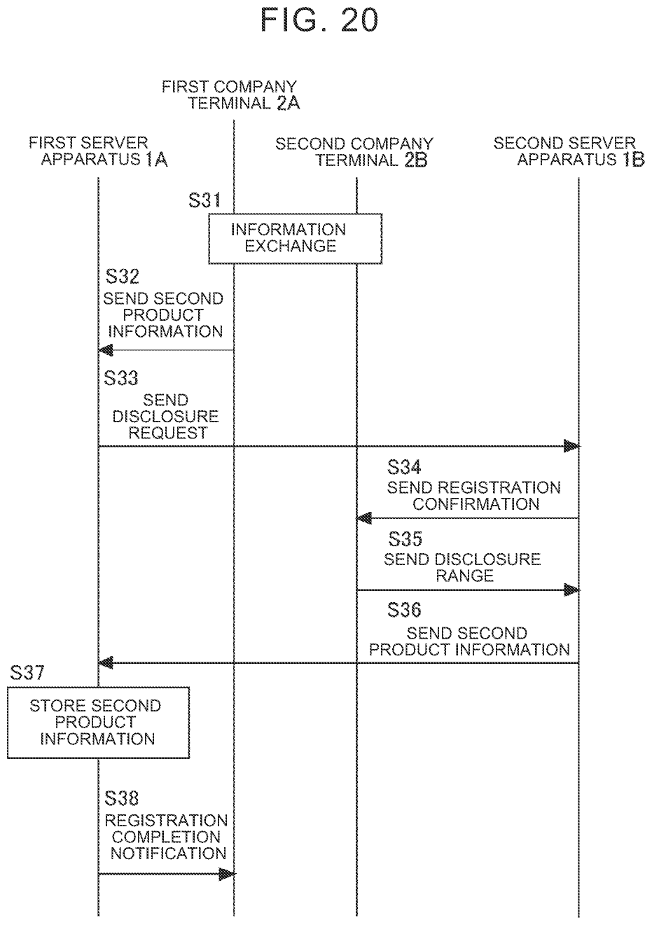

FIG. 20 is a sequence diagram that shows an example of the flow of a process in which the first server apparatus 1A acquires second product information from the second server apparatus 1B.

In an example of the present embodiment, it is assumed that interaction between the server apparatus 1 and the company terminal 2 is started when the operator of each company logs onto the server apparatus 1 by using the corresponding account of the company via the company terminal 2. In this example, it is assumed that the operator of each company has logged onto the server apparatus 1 by using its own company's account. In addition, it is also assumed that first product information is already stored in the first server apparatus 1A and second product information is already stored in the second server apparatus 1B.

When the operator of the first company desires to register the second product information in the first server apparatus 1A, information is exchanged between the first company terminal 2A and the second company terminal 2B (step S31). For example, inquiries about whether the second company accepts to register the second product information in the first platform are sent from the proxy application unit 215 of the first company terminal 2A to the proxy application unit 215 of the second company terminal 2B. For example, inquiries about whether the second company has joined another platform and whether, when the second company has joined another platform, the second product information stored in another platform is available are sent from the proxy application unit 215 of the first company terminal 2A to the proxy application unit 215 of the second company terminal 2B. When the operator of the second company accepts these inquiries, information on the second platform and identification information of the second product A12 in the second platform are sent from the proxy application unit 215 of the second company terminal 2B to the proxy application unit 215 of the first company terminal 2A.

When the operator of the second company accepts to register the second product A12 in the first platform, the proxy application unit 215 of the first company terminal 2A sends the information on the second product A12 to the first server apparatus 1A (step S32). The information on the second product A12 includes information used for the proxy input unit 116 of the first server apparatus 1A to acquire the product information of the second product A12 from the second server apparatus 1B. In an example, the information on the second product A12 includes the identification information of the second product A12 and the information on the second platform (which may be the second server apparatus 1B).

Subsequently, in step S33, the proxy input unit 116 of the first server apparatus 1A sends a disclosure request to the second server apparatus 1B. The disclosure request is to make a request to disclose the product information of the second product A12 and includes the identification information of the second product A12. The proxy input unit 116 of the first server apparatus 1A identifies a destination to which the disclosure request is sent, based on the information on the second platform, included in the information received from the first company terminal 2A.

The proxy input unit 116 of the second server apparatus 1B having received the disclosure request sends registration confirmation to the second company terminal 2B (step S34). The registration confirmation includes inquiries about whether the product information of the second product A12 is allowed to be disclosed to the first server apparatus 1A and inquiries about the range of disclosure. The range of disclosure is to define companies to which authority to access the product information is given and is information to designate what company access authority is given to. Ordinarily, through information exchange in step S31, the first company terminal 2A obtains acceptance to disclose the second product information to the first server apparatus 1A and the range of disclosure of the second product information from the second company terminal 2B. Therefore, inquiries about the range of disclosure may be inquiries about whether companies permitted to access are limited to the first company. The proxy input unit 116 of the second server apparatus 1B may provide a user interface screen such that the operator of the second company is able to input disclosable companies and allow the operator to designate downstream companies permitted to access the second product information. The range of disclosure agreed through information exchange in step S31 may be sent from the proxy application unit 215 of the first company terminal 2A to the first server apparatus 1A and may also be sent from the proxy input unit 116 of the first server apparatus 1A to the second server apparatus 1B. In this case, the proxy input unit 116 of the second server apparatus 1B may show the received range of disclosure to the second company terminal 2B and make inquiries about whether to accept the range of disclosure. The range of disclosure shown at this time may be corrected by the operator of the second company terminal 2B.

The proxy application unit 215 of the second company terminal 2B acquires acceptance to disclose the second product information to the first server apparatus 1A and the range of disclosure of the second product information via the operator and sends them to the second server apparatus 1B (step S35). The proxy application unit 215 of the second company terminal 2B, for example, receives acceptance to disclose the second product information to the first server apparatus 1A and input of information to designate downstream companies permitted to access (permission information) via the operator. The proxy application unit 215 sends information according to input information (for example, in a case of acceptance, information indicating permission of disclosure and the range of disclosure) to the second server apparatus 1B. In another example, the second company may permit disclosure of the second product information in advance. Alternatively, the disclosure request of step S33 may include information indicating permission of disclosure by the second company. In these cases, the processes of step S34 and step S35 may be omitted.

The proxy input unit 116 of the second server apparatus 1B sends the first server apparatus 1A second product information corresponding to the designated range of disclosure in response to the disclosure request (step S36). At this time, permission information is also sent.

The second product information and permission information sent are received by the proxy input unit 116 of the first server apparatus 1A and are stored in the storage unit 12 (step S37). The proxy input unit 116 of the first server apparatus 1A stores the second product information in the storage unit 12 in association with the first company. At this time, the proxy input unit 116 generates a proxy input flag field and stores “1” in the proxy input flag field. The proxy input unit 116 of the first server apparatus 1A gives authority to access the second product information based on the permission information received. In this step, the proxy input unit 116 give authority to access the second product information to the first company by, for example, copying the second product information to a storage area of which access authority is given to the first company.

When the second product information is stored in the storage unit 12, the proxy input unit 116 of the first server apparatus 1A sends registration completion notification to the first company terminal 2A (step S38). Registration completion notification is notification indicating that registration of the second product information is complete.

As described above, in the present embodiment, in the system that generates a product tree by collecting product information from the company terminals 2, it is possible to acquire upstream-side second product information from the second platform and store the second product information in the first platform in response to a request from the downstream-side first company terminal 2A. With the above configuration, time and effort to input the second product information multiple times is reduced in the second company. The second company does not need to join the first platform. Furthermore, since the second product information is available even in the first platform to which the second company has not input the second product information, it is possible to ensure traceability. Since it is possible to limit the range of disclosure of the second product information, it is possible to suppress disadvantage of the second company.

### Second Embodiment

In the first embodiment, the first server apparatus 1A stores second product information acquired from the second server apparatus 1B. However, even with the same products, the CO₂ emission amount may vary depending on the location of the platform. For example, the percentage of electric power generated by using renewable energy of electric power supplied to each company depends on a country or region where products are produced. For products produced in a region where the utilization factor of renewable energy is high, the CO₂ emission amount in the manufacturing process reduces. Therefore, when the location of the first platform is different from the location of the second platform, the accuracy of calculating CFP may decrease if second product information is directly used.

For this reason, the proxy input unit 116 of the first server apparatus 1A converts the CO₂ emission amount acquired from the second server apparatus 1B based on the location of the first platform and the location of the second platform and stores the converted CO₂ emission amount in the storage unit 12 of the first server apparatus 1A. Here, the location of the first platform and the location of the second platform are regions from which traceability-related information is collected. For example, in the case of a platform intended for Japan, the location is Japan if the server apparatus 1 is located in a country other than Japan.

The proxy input unit 116 of the first server apparatus 1A acquires information on the location of each of the first platform and the second platform. Information stored in the storage unit 12 of each server apparatus 1 may be used as information on the location of a corresponding one of the platforms. Furthermore, the proxy input unit 116 of the first server apparatus 1A may acquire information on the utilization factor of renewable energy corresponding to each location. The utilization factor of renewable energy is a ratio of the amount of electric power generated by renewable energy to the amount of electric power generated in each location. The ratio may be a value announced by a power company or a government in each country or each region. Hereinafter, the utilization factor of renewable energy in the first platform is referred to as a first utilization factor, and the utilization factor of renewable energy in the second platform is referred to as a second utilization factor.

The proxy input unit 116 of the first server apparatus 1A, for example, obtains a coefficient by calculating (1−(First utilization factor)/(1−(Second utilization factor)). Then, the CO₂ emission amount is converted by multiplying the coefficient by the CO₂ emission amount included in the second product information. A method of converting the CO₂ emission amount is not limited thereto. For example, the CO₂ emission amount may be converted so as to reduce as the first utilization factor becomes further higher than the second utilization factor or the CO₂ emission amount may be converted so as to increase as the first utilization factor becomes further lower than the second utilization factor. This conversion expression is stored in the storage unit 12.

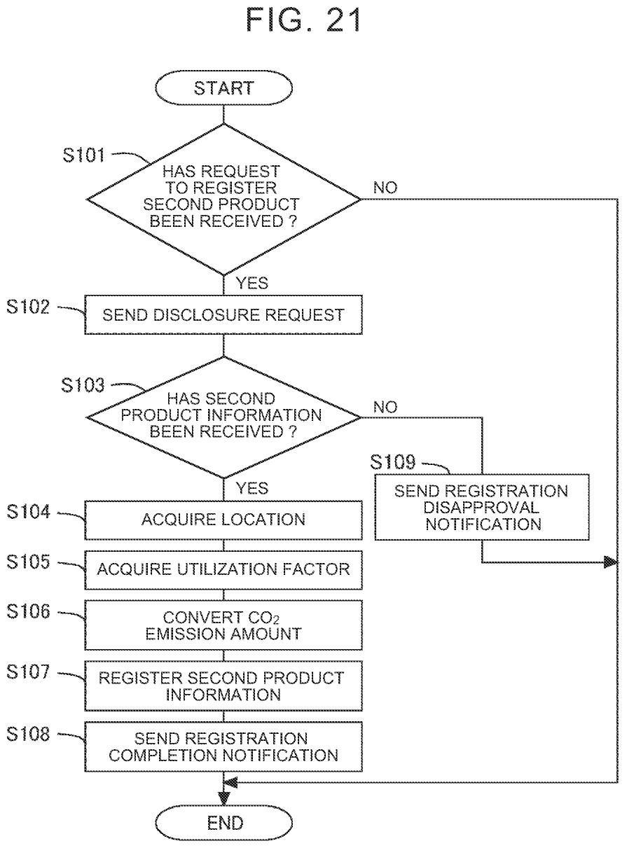

FIG. 21 is a flowchart that shows the flow of a process of registering the second product A12, executed in the first server apparatus 1A. The routine is executed at intervals of a predetermined period of time in the first server apparatus 1A. Description will be made on the assumption that first product information is already stored in the first server apparatus 1A and second product information is already stored in the second server apparatus 1B.

In step S101, the proxy input unit 116 determines whether a request to register the second product A12 has been received. The registration request includes information on the second product A12. The information on the second product A12 here includes the identification information of the second product A12 and the information on the second platform (which may be the second server apparatus 1B). When the proxy input unit 116 makes affirmative determination in step S101, the process proceeds to step $102; whereas, when the proxy input unit 116 makes negative determination in step S101, the routine ends.

In step S102, the proxy input unit 116 sends a disclosure request to the second server apparatus 1B. The disclosure request is to make a request to disclose the product information of the second product A12 and includes the identification information of the second product A12. The proxy input unit 116 identifies a destination to which the disclosure request is sent, based on the information on the second platform, included in the information received from the first company terminal 2A.

In step S103, the proxy input unit 116 determines whether the second product information has been received, in response to the disclosure request from the second server apparatus 1B. When the second platform or the second company refuses to disclose the second product information, the second product information is not sent, and notification about refusal of disclosure is provided. When the proxy input unit 116 makes affirmative determination in step S103, the process proceeds to step S104; whereas, when the proxy input unit 116 makes negative determination in step S103, the process proceeds to step S109. In step S109, the proxy input unit 116 sends registration disapproval notification to the first company terminal 2A. Registration disapproval notification is notification about the fact that product information is not allowed to be registered in the first server apparatus 1A. The registration disapproval notification includes the identification information of the second product.

In step S104, the proxy input unit 116 acquires the location of the first platform and the location of the second platform. The location of the first platform (hereinafter, also referred to as first location) is stored in the storage unit 12 of the first server apparatus 1A. The location of the second platform (hereinafter, also referred to as second location) may be acquired from the second platform by making inquiries of the second platform or may be acquired from another server apparatus that stores a relationship between the second platform and the location.

In step S105, the proxy input unit 116 acquires the utilization factor of renewable energy of each of the first location and the second location. The utilization factor of renewable energy corresponding to each location is, for example, disclosed by a government or a power company, so the proxy input unit 116 accesses a server apparatus that discloses the utilization factor of renewable energy and acquires the utilization factor of renewable energy. The utilization factor of renewable energy in each location may be stored in a corresponding one of the server apparatuses 1. In this case, the proxy input unit 116 may acquire the utilization factor of renewable energy of the second location from the second server apparatus 1B.

In step S106, the proxy input unit 116 converts the CO₂ emission amount included in the second product information. The information collecting unit 111 converts the CO₂ emission amount included in the second product information such that the CO₂ emission amount reduces as the first utilization factor becomes further higher than the second utilization factor. This conversion is, for example, performed by using a calculation formula stored in the storage unit 12.

In step S107, the proxy input unit 116 replaces the CO₂ emission amount included in the second product information with the CO₂ emission amount converted in step S106 and stores the second product information in the storage unit 12. In step S108, the proxy input unit 116 sends registration completion notification to the first company terminal 2A. Registration completion notification is notification indicating that registration of the second product information is complete.

As described above, in the present embodiment, the CO₂ emission amount included in the second product information can be automatically converted based on the location of each platform. Therefore, it is possible to reduce time and effort that the operator of the second company converts information.

### Other Embodiments

The above-described embodiments are only illustrative, and the disclosure can be implemented with modifications as needed without departing from the purport of the disclosure. For example, the processes and devices described in this disclosure may be freely implemented in combination without any technical contradiction.

In the description of the embodiments, the server apparatus 1 stores product information in the database. Alternatively, product information may be stored by a device other than a database.

In the description of the embodiments, a mode in which a product tree is completed when the server apparatus 1 executes the first to fourth phases has been illustrated. Alternatively, a role of the server apparatus 1 may be distributed to the company terminals 2. For example, product information may be stored by a distributed database using a blockchain platform. In this case, a product information database may be made up of the company terminals 2. In this case, the above-described processes of the phases may be executed by using smart contract. For example, on condition that the account of a company writes permission information to a database, a process in the second phase may be executed. On condition that the account of a company writes an association request to the database, a process in the third phase may be executed.

In the description of the embodiments, the phase in which the server apparatus 1 receives product information on an upstream product and the phase in which the server apparatus 1 receives permission information corresponding to the product information have been described separately; however, both may be received at the same time. Similarly, in the description of the embodiments, the phase in which the server apparatus 1 receives product information on a downstream product and the phase in which the server apparatus 1 receives an association request corresponding to the product information have been described separately; however, both may be received at the same time.

In the description of the embodiments, the first platform is provided by the first server apparatus 1A; however, the configuration is not limited thereto. For example, the first server apparatus 1A may be a server independent of the first platform and provides the first platform with information obtained from the second platform.

In the above-described embodiments, access control of each company is implemented by providing a dedicated storage area and a shared storage area. However, a method of implementing access control is not limited to such an example. A selected method may be used for access control.

In the above-described embodiments, the method using the utilization factor of renewable energy has been illustrated as a method of correcting the CO₂ emission amount according to a difference in location. However, a method of correcting the CO₂ emission amount according to a difference in location may be not limited to such an example. In another example, in addition to or instead of the utilization factor of renewable energy, information on transport, such as a transport distance and a transport device in each location, may be used. In this case, in step S106, the first server apparatus 1A may convert the CO₂ emission amount such that a difference in transport between the locations is corrected.

In the above-described embodiments (FIG. 1), a plurality of companies included in a supply chain has been described as companies that produce products. However, companies included in a supply chain do not necessarily need to be companies that produce products. For example, companies that perform transport, import, storage, wholesale, and the like of products may be included in companies that make up a supply chain. In an example, some companies of a plurality of companies may be, for example, companies that do not execute a manufacturing process, such as a trading company, a distributing agent, and an import agent, or may receive products from a company at a level upstream by one (upstream company) and supplies products to a company at a level downstream by one (downstream company).

In the above-described embodiments, a supply chain of products relevant to automobiles have been assumed, an OEM maker has been described as the most downstream company, and a company that supplies parts, materials, assemblies, and the like has been described as a supplier. However, companies that belong to a supply chain are not necessarily limited to these. Companies in each phase may be determined as needed according to products and the like. Manufacturing activities performed in each company by the time an end product is obtained may be determined as needed according to an embodiment and may, for example, include all the activities that can be performed by the time an end product is obtained, such as excavation, working, assembling, conveyance, and storage.

In the above-described embodiments, the server apparatus 1 is configured to execute information processing of the first to fourth phases in addition to information processing on a request to disclose information to another platform (FIG. 20 and FIG. 21). However, the configuration of the server apparatus 1 does not need to be limited to such an example. In an example, in the server apparatus 1, information processing in at least one or some of the first to fourth phases may be omitted. The server apparatus 1 may be configured to execute other selected information processing.

In the above-described embodiments, an example of calculation of the CO₂ emission amount (CFP value) has been described. A CFP value may be calculated by using the following calculation formula.

(CFP value of TierN−1)=(Own company measured CFP value of TierN−1)+Σₖ(CFP value of k company (TierN)×Amount of use uₖ in TierN−1)

Here, “CFP value of TierN-1” indicates a result obtained by integrating a CFP value of an upstream company (k company (TierN)) with its own company's CFP value. The own company measured CFP value indicates a CFP value included in product information of each company. When TierN is the most upstream company, “CFP value of TierN” is a CFP value included in product information of the company; whereas, in other cases, “CFP value of TierN” is a result obtained by integrating a CFP value of a further upstream company (TierN+1) with a CFP value included in product information of the company. A CFP value of a Tier0 product (=end product) can be obtained by setting TierN for the most upstream company (termination company) and repeating calculation up to N=1.

In the above-described embodiments, the server apparatus 1 may execute computation of recycling rate and due diligence (score) in addition to or instead of calculation of the CO₂ emission amount (CFP value). The recycling rate may be calculated by using the following calculation formula.

(Recycling rate at TierN−1 product for a target substance)={(Total amount of use in TierN−1)×(Recycling rate in TierN−1)+Σₖ((Total amount of use in k company (TierN))×(Recycling rate in k company (TierN))×(Amount of use uₖ in TierN−1))}÷{(Total amount of use in TierN−1)+Σₖ((Total amount of use in k company (TierN))×(Amount of use uₖ in TierN−1))}={(Recycled material usage amount in TierN−1)+Σk((Recycled material usage amount in k company (TierN))×(Amount of use uₖ in TierN−1)}={(Total amount of use in TierN−1)+Σk((Total amount of use in k company (TierN))×(Amount of use uₖ in TierN−1))}

A recycled material usage amount indicates the amount of use of a recycled material of a target substance. As in the case of CFP value, a recycling rate at an end product for a target substance can be calculated by sequentially calculating from the most upstream company (termination company). A due diligence score (DD score) can also be integrated with similar computation to those of the CFP value and the recycling rate. In an example, a DD score (integrated result) at an end product can be obtained by replacing the CFP value with a DD score and sequentially calculating from the most upstream company (termination company).

In the above-described embodiments, traceability-related information of each company (TierN−1) itself except the most upstream company does not need to be stored in a shared storage area with its own downstream company, and an integrated result (the CFP value of TierN−1 and the recycling rate at TierN−1 product for a target substance) of each company may be stored in a shared storage area between the company and a downstream company (TierN−2) of the company. Thus, traceability-related information (integrated result) at an end product can be obtained without disclosing its own company's traceability-related information.

In the above-described embodiments, it is assumed that each company places an order with one company for a material. However, in the above-described embodiments, an order form of each company does not need to be limited to such an example. At least some of companies that belong to a supply chain may place an order with a plurality of upstream companies for the same product and selectively use the obtained upstream products for its own company's product. For example, in the example of FIG. 13, a product A11_1, a product A11_2, or a product A11_3 of Tier2 may be selectively used for the product A1 of Tier1. In this case, the server apparatus 1 may hold an association relationship for each pattern used. In the above example, the server apparatus 1 may hold association information for the product A1 of Tier1 like pattern 1 “product A11_1, . . . , of Tier2”, pattern 2 “product A11_2, . . . ”, and pattern 3 “product A11_3, . . . ”. Accordingly, the server apparatus 1 may execute computation (integration) of the traceability-related information for each pattern. In this case, in an example, the server apparatus 1 may output a computation result for each pattern. In another example, the server apparatus 1 may calculate a statistic, such as a maximum value, a minimum value, a mean value, a variance, a standard deviation, and a median value, of computation results from the computation results and output the calculated static.

In the above-described embodiments, traceability-related information (particularly, CFP value) may be composed of primary data or may be composed of secondary data (inventory data). Primary data are measurement values, and secondary data are reference values used when no measurement value is obtained. In this case, computation (integration) of the traceability-related information may include calculating the ratio of primary data of traceability-related information obtained for an end product. The ratio of primary data may be calculated by simple ratio calculation or may be calculated by weighted calculation performed by replacing the CFP value with the ratio of primary data of each company in the calculation formula of the CFP value and sequentially calculating from the most upstream company.

A process described as the one that is performed by a device may be shared and performed by multiple devices. Alternatively, processes described as the ones that are respectively performed by different devices may be performed by a device. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An information processing apparatus comprising a controller configured to:
receive, from a terminal of a first company that belongs to a first platform, identification information of a second product of a second company and information on a second platform in which information on the second product is registered, the second company being positioned upstream of a first product of the first company in a supply chain;
send a disclosure request for the information on the second product to the second platform, the disclosure request including the identification information of the second product;
receive the information on the second product from the second platform in response to the disclosure request; and
register the information on the second product in association with the first company.

2. The information processing apparatus according to claim 1, wherein the information on the second product includes traceability-related information of the second product.

3. The information processing apparatus according to claim 2, wherein the traceability-related information includes information on an amount of emission of greenhouse effect gas.

4. The information processing apparatus according to claim 3, wherein:
the controller is configured to acquire information on a location of the first platform and a location of the second platform;
the controller is configured to convert the information on the amount of emission of the greenhouse effect gas according to a relationship between the location of the first platform and the location of the second platform; and
the information on the second product includes the converted information on the amount of emission of the greenhouse effect gas.

5. The information processing apparatus according to claim 1, wherein the controller is configured to perform at least one of the sending and the receiving via a predetermined connector.

6. The information processing apparatus according to claim 1, wherein the controller is configured to register the information about the second product in association with the first company by registering the first company as an administrator of the information on the second product.

7. The information processing apparatus according to claim 1, wherein:
a disclosure range of the information on the second product is designated through a terminal of the second company; and
the information on the second product is received from the second platform by the controller.

8. The information processing apparatus according to claim 1, wherein the first product and the second product are products related to a battery.

9. An information processing method comprising: by a computer,
receiving, from a terminal of a first company that belongs to a first platform, identification information of a second product of a second company and information on a second platform in which information on the second product is registered, the second company being positioned upstream of a first product of the first company in a supply chain;
sending a disclosure request for the information on the second product to the second platform, the disclosure request including the identification information of the second product;
receiving the information on the second product from the second platform in response to the disclosure request; and
registering the information on the second product in association with the first company.

10. The information processing method according to claim 9, wherein the information on the second product includes traceability-related information of the second product.

11. The information processing method according to claim 10, wherein the traceability-related information includes information on an amount of emission of greenhouse effect gas.

12. The information processing method according to claim 11, further comprising:
by the computer,
acquiring information on a location of the first platform and a location of the second platform; and
converting the information on the amount of emission of the greenhouse effect gas according to a relationship between the location of the first platform and the location of the second platform, wherein
the registering the information on the second product includes registering the converted information on the amount of emission of the greenhouse effect gas in association with the first company.

13. The information processing method according to claim 9, further comprising performing at least one of the sending and the receiving via a predetermined connector.

14. The information processing method according to claim 9, wherein the registering the information on the second product in association with the first company includes registering the first company as an administrator of the information on the second product.

15. The information processing method according to claim 9, wherein:
a disclosure range of the information on the second product is designated through a terminal of the second company; and
the information on the second product is received from the second platform by the computer.

16. The information processing method according to claim 9, wherein the first product and the second product are products related to a battery.

17. A non-transitory storage medium storing instructions that are executable on one or more processors in a computer and that cause the one or more processors to perform functions, the functions comprising:
receiving, from a terminal of a first company that belongs to a first platform, identification information of a second product of a second company and information on a second platform in which information on the second product is registered, the second company being positioned upstream of a first product of the first company in a supply chain;
sending a disclosure request for the information on the second product to the second platform, the disclosure request including the identification information of the second product;
receiving the information on the second product from the second platform in response to the disclosure request; and
registering the information on the second product in association with the first company.

18. The non-transitory storage medium according to claim 17, wherein the information on the second product includes traceability-related information of the second product.

19. The non-transitory storage medium according to claim 18, wherein the traceability-related information includes information on an amount of emission of greenhouse effect gas.

20. The non-transitory storage medium according to claim 19, the functions further comprising:
acquiring information on a location of the first platform and a location of the second platform; and
converting the information on the amount of emission of the greenhouse effect gas according to a relationship between the location of the first platform and the location of the second platform, wherein
the registering the information on the second product includes registering the converted information on the amount of emission of the greenhouse effect gas in association with the first company.
